(19) United States
(12) Patent Application Publication
(10) Pub. No.: US 2025/0278218 A1
(43) Pub. Date: Sep. 4, 2025

(54) STORAGE MEDIUM AND CONTROL METHOD FOR PERFORMING COLOR REDUCTION OF PRINT DATA TO MAKE PRINT DATA PRINTABLE BY PRINTING APPARATUS

(71) Applicant: CANON KABUSHIKI KAISHA, Tokyo (JP)

(72) Inventor: HIROYUKI SAKAI, Chiba (JP)

(21) Appl. No.: 19/050,439

(22) Filed: Feb. 11, 2025

(30) Foreign Application Priority Data
Mar. 1, 2024 (JP) 2024-031327

(51) Int. Cl. G06F 3/12; H04N 1/60

(52) U.S. Cl. CPC G06F 3/1205; G06F 3/1208; G06F 3/1232; G06F 3/1256; G06F 3/1287; H04N 1/6058

(57) ABSTRACT

Storage media and control methods for performing color reduction processing on print data are provided. A non-transitory computer-readable storage medium stores an executable program configured for supporting a general-purpose program that generates data printable by various printing apparatuses. The program causes a computer, such as an information processing apparatus communicably connected to a printing apparatus, to execute processing of causing a display to display a setting reception screen for color reduction processing. The program further causes the computer to execute processing of transmitting a setting for the color reduction processing received through the setting reception screen to the printing apparatus, or of converting data generated by the general-purpose program into print data using the received setting for the color reduction processing and then transmitting the print data to the printing apparatus.

### BACKGROUND OF THE INVENTION

### Field of the Invention

The present invention relates to storage media and control methods.

### Description of the Related Art

A known print system includes a printing apparatus that performs printing and a host computer (information processing apparatus) that is communicatively connected to the printing apparatus and capable of processing information with the printing apparatus, in which the host computer issues print instructions to the printing apparatus. To control the printing apparatus, for example, a printer driver is installed from the printing apparatus into the host computer, and is used as control software. With this printer driver, a user is allowed to issue a print instruction from the host computer to the printing apparatus.

An operating system (hereinafter, referred to as an “OS”) that is basic software is installed in the host computer in advance. Printer drivers are configured in accordance with specifications defined by the OS, and are invoked from the OS to operate. Such printer drivers differ depending on vendors supplying printing apparatuses, that is, they are model-specific printer drivers that are suitable for respective printing apparatuses to be used.

In recent years, Windows (registered trademark) has been provided with a standard class driver (hereinafter, referred to as a “standard driver” in some cases) that is commonly usable by printing apparatuses provided by a plurality of vendors. The standard driver is packaged together with the OS and users can easily use the standard driver for printing on an arbitrary printing apparatus when the printing apparatus is connected to the host computer having the OS with the standard driver incorporated therein. In this manner, it is possible to omit installation of the model-specific printer driver into the host computer.

The standard driver is configured to designate a print function to be used in a printing apparatus in accordance with print device capabilities (hereinafter referred to as “PDC”) generated on the basis of information acquired from the printing apparatus. This allows a user who uses the standard driver to designate a print function corresponding to the capability of the printing apparatus via the one standard driver.

The standard driver can be associated with a function extension application (hereinafter, referred to as an “extension application” in some cases) that extends functions of the standard driver. An extension application is provided by a vendor that supplies printing apparatuses, and provides a function (extended function) that cannot be achieved only by the standard driver.

Japanese Laid-Open Patent Publication (kokai) No. 2021-93081 discloses a support program used at the time of printing by a printer communicatively connected to an information processing apparatus. In a case where a print instruction has been sent to a general-purpose print program pre-installed in an operating system of an information processing apparatus and a saving mode of saving colorant (toner or ink) has been selected, the support program causes a computer to perform an adjustment to reduce the consumption of the colorant. This adjustment function is not included in the general-purpose printing program, but can be executed using the support program.

Examples of functions provided by an extension application include a two-color print function as well as the adjustment function, and the two-color print function is one of device-specific functions that correspond to the capabilities of printing apparatuses supplied by various venders. The “two-color print function” is a function for printing image data, which is available for full-color printing, in predetermined two colors by a printing apparatus. With the two-color print function, for example, it is possible to print image data, which is available for full-color printing, in two colors, such as green and black or red and black, using a printing apparatus. In this manner, it is possible to print image data in two colors of user's preference, for example, using a printing apparatus even if the image data is available for full-color printing.

However, the support program described in Japanese Laid-Open Patent Publication (kokai) No. 2021-93081 is not configured to execute the two-color print function. As a result, there is room for improvement in printing image data in two colors of a user's preference.

### SUMMARY OF THE INVENTION

The present invention provides structures and methods that enable color reduction processing of reducing kinds of colors included in print data, which is targeted for printing by a printing apparatus, to two or more kinds of colors and of causing the printing apparatus to print the resulting print data.

According to an aspect of the invention, a non-transitory computer-readable storage medium stores a program which is executed by a computer and is configured for supporting a general-purpose program that generates data being printable by printing apparatuses from a plurality of manufacturers. The program causes the computer to execute: causing a display to display a setting reception screen that receives a setting for color reduction processing; and transmitting a setting for the color reduction processing received through the setting reception screen to a printing apparatus. The color reduction processing is processing of reducing kinds of colors included in print data, which is targeted for printing by the printing apparatus, to two or more kinds of colors and of causing the printing apparatus to print the print data.

According to another aspect of the invention, a non-transitory computer-readable storage medium stores a program which is executed by a computer and is configured for supporting a general-purpose program that generates data being printable by printing apparatuses from a plurality of manufacturers. The program causes the computer to execute causing a display to display a setting reception screen that receives a setting for color reduction processing. The color reduction processing is processing of reducing kinds of colors included in print data, which is targeted for printing by a printing apparatus, to two or more kinds of colors and of causing the printing apparatus to print the print data. The program further causes the computer to execute performing conversion processing; and transmitting print data converted through the conversion processing to the printing apparatus. The conversion processing is processing of converting data generated by the general-purpose program into the print data to be subjected to printing based on the color reduction processing with a setting for the color reduction processing received through the setting reception screen; and transmitting the print data converted through the conversion processing to the printing apparatus.

According to another aspect of the invention, an information processing apparatus is communicatively connected to a printing apparatus and is configured to process information with the printing apparatus. The information processing apparatus includes a processor, and one or more memories storing a general-purpose program that generates data being printable by printing apparatuses from a plurality of manufacturers, and a program that supports the general-purpose program. The program, when executed by the processor, causes the information processing apparatus to cause a display to display a setting reception screen that receives a setting for the color reduction processing, and to transmit a setting for the color reduction processing received through the setting reception screen to the printing apparatus.

According to another aspect of the invention, an information processing apparatus is communicatively connected to a printing apparatus and is configured to process information with the printing apparatus. The information processing apparatus includes a processor, and one or more memories storing a general-purpose program that generates data being printable by printing apparatuses from a plurality of manufacturers, and a program that supports the general-purpose program. The program, when executed by the processor, causes the information processing apparatus to cause a display to display a setting reception screen that receives a setting for the color reduction processing; to perform conversion processing of converting data generated by the general-purpose program into the print data to be subjected to printing based on the color reduction processing with a setting for the color reduction processing received through the setting reception screen; and to transmit the print data converted through the conversion processing to the printing apparatus.

According to the present invention, it is possible to perform color reduction processing of reducing kinds of colors included in print data, which is targeted for printing by a printing apparatus, to two or more kinds of colors and of causing the printing apparatus to print the resulting print data.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of a printing system according to a first embodiment.

FIGS. 2A and 2B are block diagrams illustrating a software configuration of the printing system.

FIGS. 2C to 2F are diagrams for explaining an execution example of a two-color print function.

FIGS. 2G to 2H are flowcharts illustrating execution of the two-color print function.

FIGS. 3A to 3D are diagrams illustrating examples of screens displayed on a display of the printing system.

FIG. 4 is a flowchart illustrating processing of editing print function information by a print function extension unit.

FIG. 5 is a diagram illustrating an example of a list of capability information on the printing apparatus.

FIG. 6 is a diagram illustrating an example of a list of print functions supported by an extension application.

FIG. 7 is a diagram illustrating an example of a list of capability information of general-purpose printing software.

FIG. 8 is a sequence diagram illustrating processing executed among a drawing application, general-purpose printing software, the extension application, and the printing apparatus after the drawing application receives print settings.

FIG. 9 is a block diagram illustrating a software configuration of a printing system according to a second embodiment.

FIG. 10 is a flowchart illustrating processing of editing print function information by a print function extension unit.

FIG. 11 is a diagram illustrating an example of a list of capability information on a printing apparatus.

FIG. 12 is a sequence diagram illustrating processing executed among a drawing application, general-purpose printing software, the extension application, and the printing apparatus after the drawing application receives print settings.

FIG. 13 is a sequence diagram illustrating processing executed among a drawing application, general-purpose printing software, an extension application, and a printing apparatus after the drawing application receives print settings in a printing system according to a third embodiment.

FIG. 14 is a sequence diagram illustrating processing executed among a drawing application, general-purpose printing software, an extension application, and a printing apparatus after the drawing application receives print settings in a printing system according to a fourth embodiment.

FIGS. 15A to 15C are diagrams illustrating examples of screens displayed on a display of the printing system.

### DESCRIPTION OF THE EMBODIMENTS

The present invention will now be described in detail below with reference to the accompanying drawings showing embodiments thereof.

The configurations described in the following embodiments are merely examples, and the scope of the present invention is not limited by the configurations described in the embodiments. For example, each unit or component constituting the present invention can be replaced with one having any configuration capable of exhibiting similar functions. In addition, any component may be added the configurations described in the embodiments. Further, any two or more configurations (features) in the embodiments may be combined.

### First Embodiment

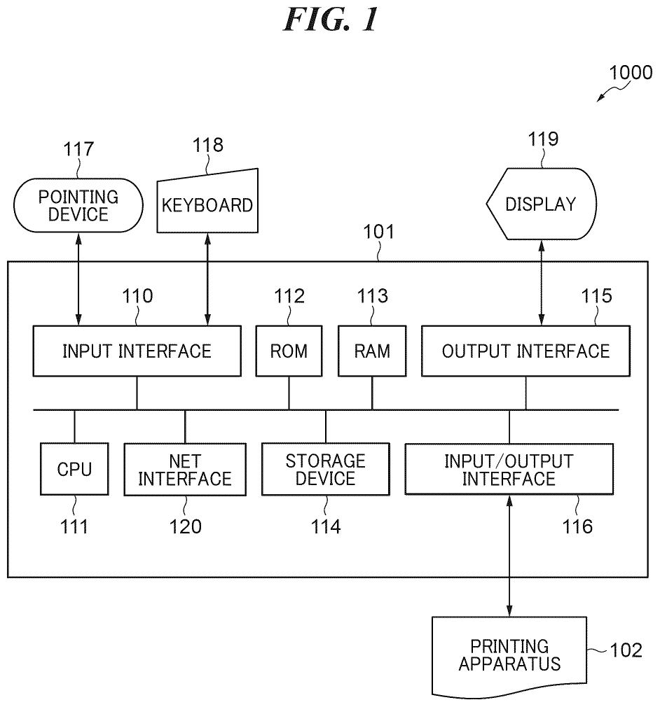

Hereinafter, a first embodiment will be described with reference to FIGS. 1 to 8.

FIG. 1 is a block diagram illustrating a hardware configuration of a printing system 1000 according to the first embodiment. As illustrated in FIG. 1, the printing system 1000 includes a host computer 101, a printing apparatus 102, a pointing device 117, a keyboard 118, and a display 119, and these are communicatively connected to each other.

The host computer 101 is an information processing apparatus and includes an input interface 110, a CPU 111, a ROM 112, a RAM 113, a storage device (storage medium) 114, an output interface 115, an input/output interface 116, and a NET interface 120. It should be noted that although it is possible to use a desktop-type personal computer, for example, as the host computer 101, but the host computer 101 is not limited thereto. It is also possible to use, for example, a laptop-type personal computer, a tablet terminal, a smartphone, or the like, as the host computer 101.

The CPU 111 is a computer that executes programs and the like stored in the ROM 112 and the storage device 114 and controls various devices and various components of the printing system 1000. The ROM 112 stores an initialization program. The storage device 114 stores an application program group, an operating system (OS), print data generation software, and other various kinds of data. It should be noted that in the present embodiment, Windows (registered trademark) 11 of Microsoft (registered trademark) is installed as the OS in the host computer 101. The RAM 113 is used as a work memory or the like when various programs stored in the storage device 114 are executed, so that the various programs can run in the host computer 101.

A pointing device 117 and a keyboard 118, which are input devices, are connected to the input interface 110. A display 119, which is a display device, is connected to the output interface 115. The display 119 is configured to display, for example, a print setting screen 300A and a detailed setting screen 300C, which will be described later. The NET interface 120 is a network interface and is configured to perform control for performing data transfer with an external device via a network. The printing apparatus 102 is connected to the input/output interface 116, and thus the host computer 101 becomes communicable with the connected printing apparatus 102 regardless of the manufacturer of the printing apparatus 102. In other words, the host computer 101 is allowed to process information with any of the printing apparatuses of manufacturers, when the printing apparatus is connected to the input/output interface 116.

Although it is possible to use, as the printing apparatus 102, a multi-function peripheral (MFP) having a plurality of functions such as copying, printing, and faxing, for example, the printing apparatus 102 is not limited thereto. Furthermore, although printing performed by the printing apparatus 102 is electrophotographic printing in the present embodiment, the printing is not limited thereto, and the printing can be printing by an ink-jet method, for example. Also, although the host computer 101 and the printing apparatus 102 are configured as separate devices in the present embodiment, the configuration is not limited thereto. For example, the host computer 101 and the printing apparatus 102 may be configured as an integrated apparatus.

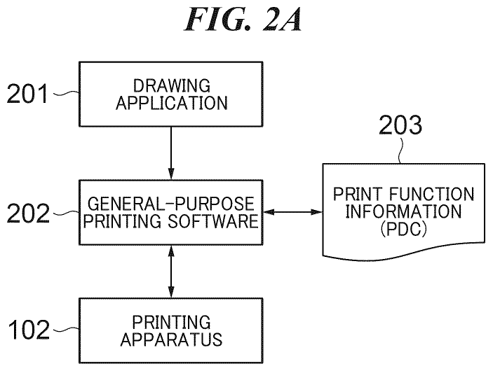

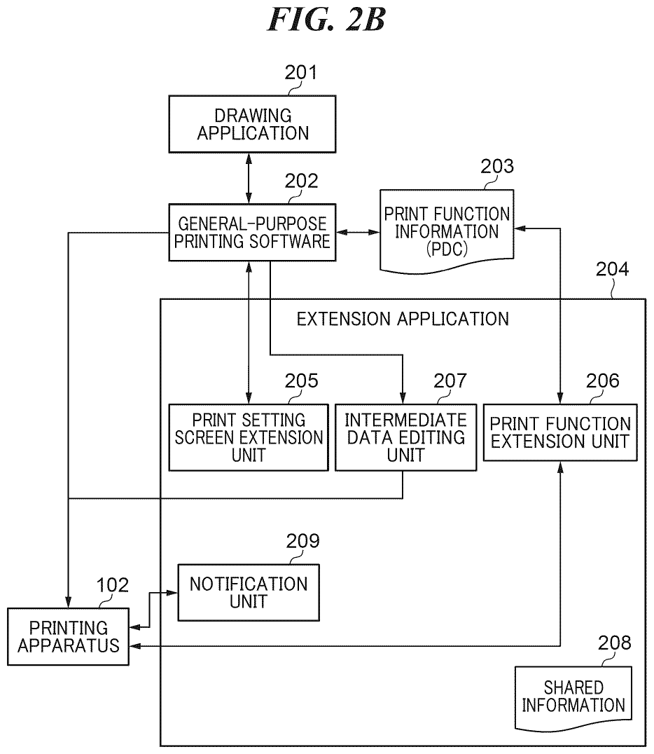

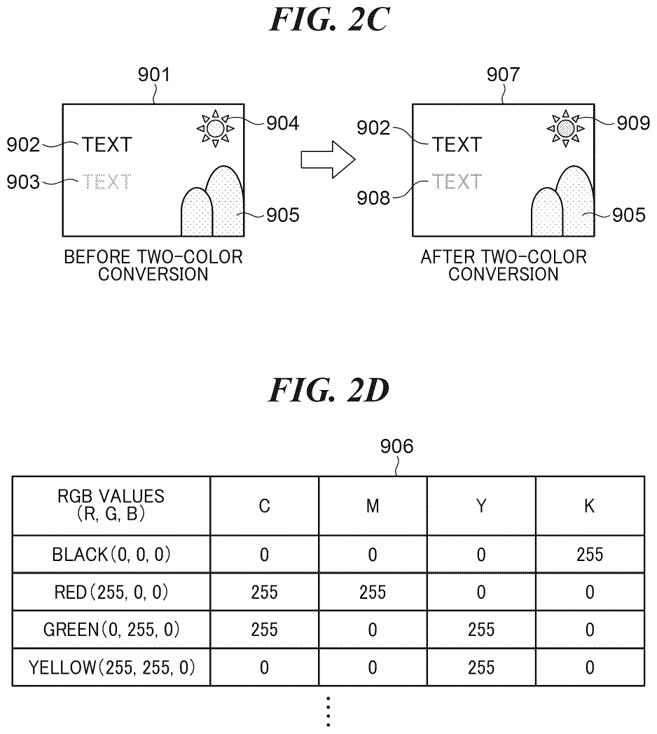

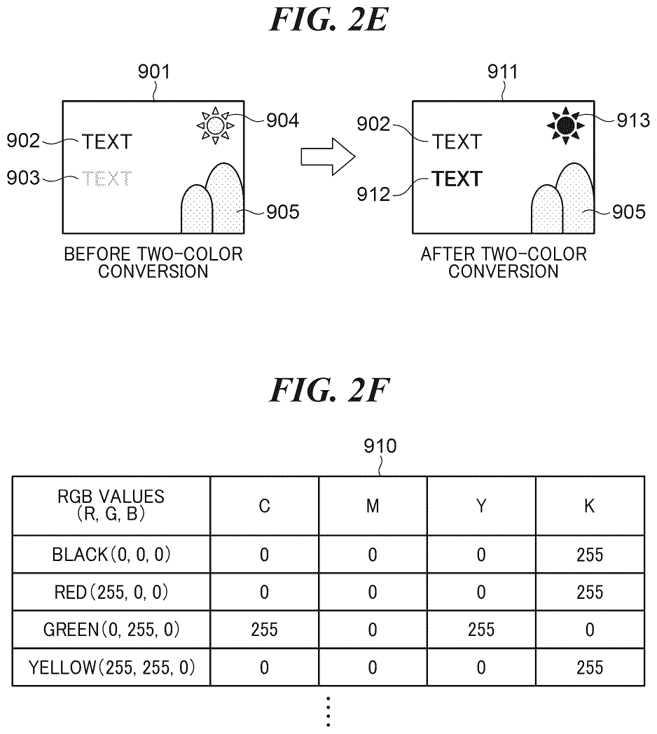

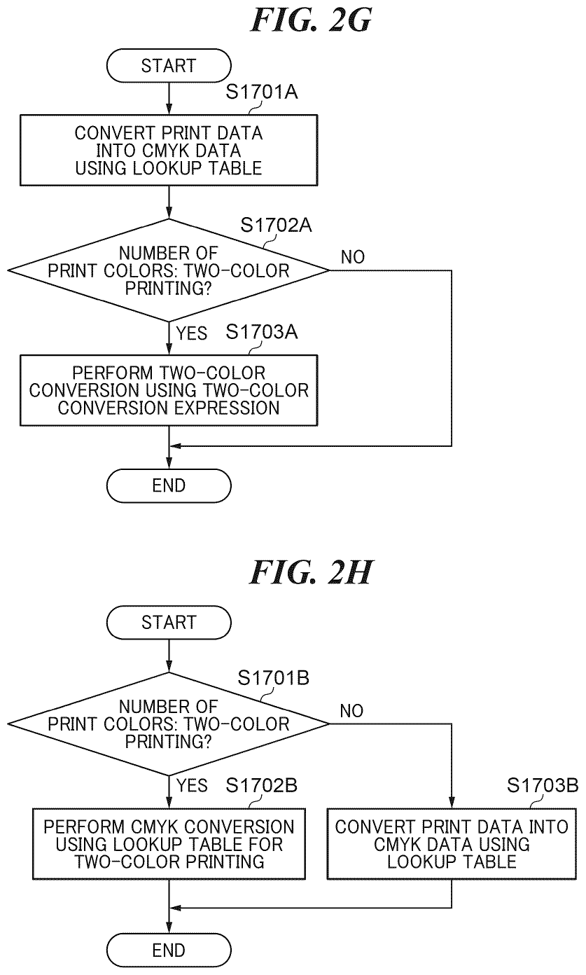

FIGS. 2A and 2B are block diagrams illustrating a software configuration of the printing system 1000. FIG. 2A is a diagram illustrating a typical software configuration of the printing system 1000 in a case where an extension application (program) 204 is not associated with a general-purpose printing software (general-purpose program) 202 and the printing apparatus 102. FIG. 2B is a diagram illustrating a software configuration of the printing system 1000 in a case where the extension application 204 is associated with the general-purpose printing software 202 and the printing apparatus 102.

The general-purpose printing software 202 is a program for generating data that is printable by printing apparatuses of a plurality of manufacturers, that is, a program that can be commonly used at the time of printing by the printing apparatuses of the manufacturers. The general-purpose printing software 202 is installed in the OS in advance. As the general-purpose printing software 202, a program that runs in accordance with Internet Printing Protocol (IPP) is used.

The extension application 204 is a program for supporting, that is, assisting the general-purpose printing software 202. Although the extension application 204 is an extension program that provides, as extended functions, functions that is not executable by the general-purpose printing software 202 on the printing apparatus 102 in the present embodiment, the extension application 204 is not limited thereto. For example, the extension application 204 may be a program that improves convenience of functions that is executable by the general-purpose printing software 202 on the printing apparatus 102. The extension application 204 is stored, for example, in the storage device 114 together with the OS (general-purpose printing software 202). As a result, the host computer 101 includes the general-purpose printing software 202 and the extension application 204 stored in one storage medium or a plurality of storage media.

With reference to FIG. 2A, the software configuration of the printing system 1000 in the case where the extension application 204 is not associated with the general-purpose printing software 202 and the printing apparatus 102 will be described.

The drawing application 201 is software that creates content (print data) to be printed by the printing apparatus 102. The drawing application 201 is not particularly limited, and examples thereof include a document creation application and a spreadsheet application.

The drawing application 201 issues a print instruction to the OS in response to receiving a print request from a user via the keyboard 118, for example. The print instruction includes print setting information for providing instruction for operations of the general-purpose printing software 202 and the printing apparatus 102. The print setting information is also called “Print Ticket (PT)”.

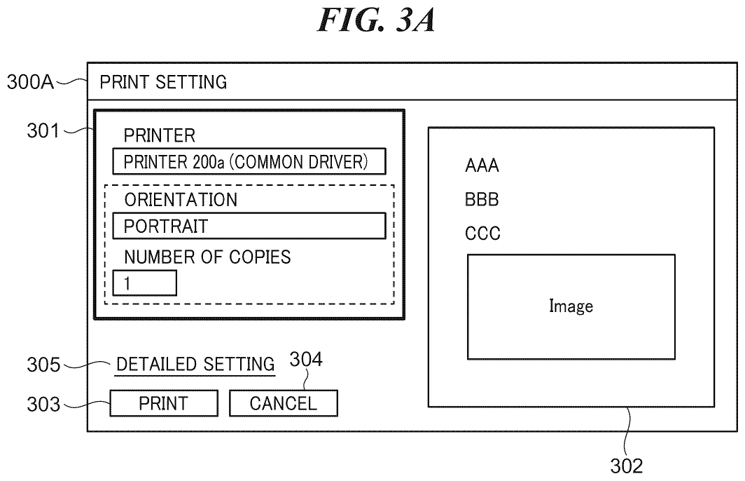

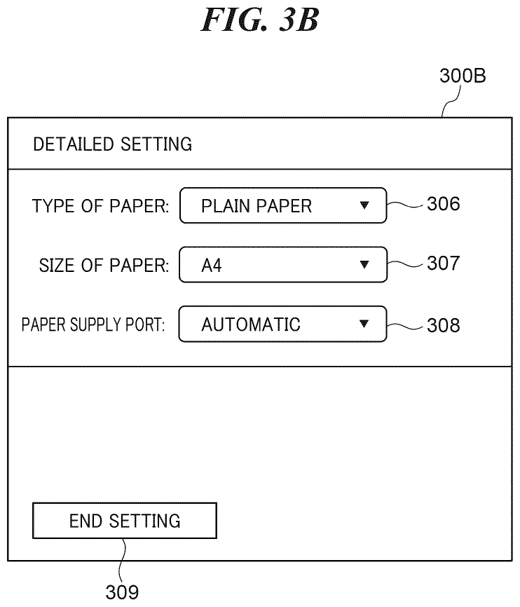

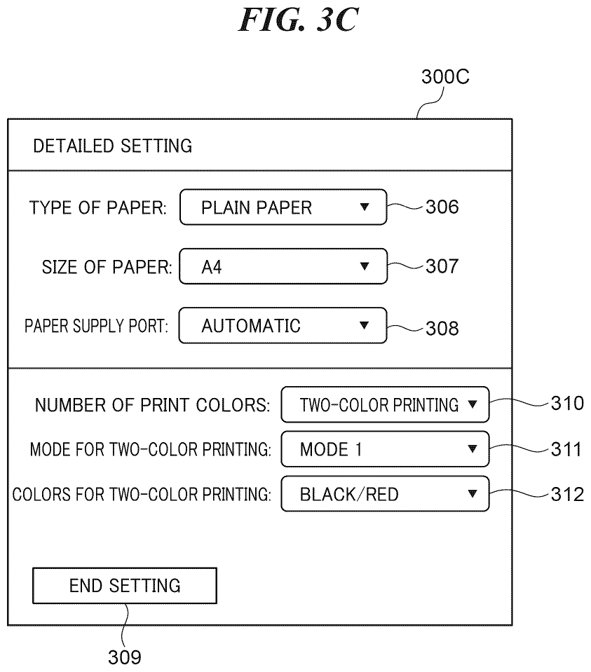

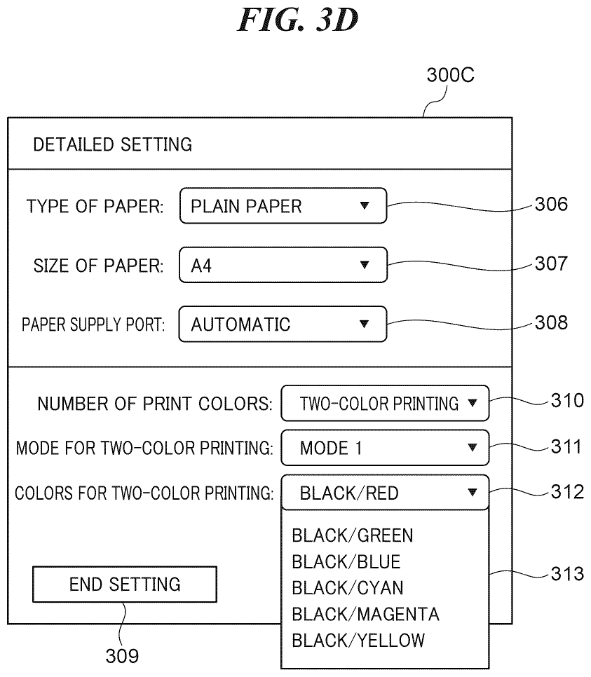

In addition, the drawing application 201 is configured to cause the display 119 to display a print setting screen 300A (see FIG. 3A) provided by any of the general-purpose printing software 202, the OS, and the drawing application 201 in order to output the print setting information. Furthermore, the drawing application 201 is configured to cause the display 119 to display a detailed setting screen 300B (see FIG. 3B) or a detailed setting screen 300C (see FIG. 3C) in response to a control 305 inside the print setting screen 300A being operated (pressed). The print setting screen 300A to the detailed setting screen 300C will be described later.

The print setting screen 300A includes setting items indicating settable print functions and control items indicating setting values for the setting items. The setting items and the control items are displayed in accordance with capability information acquired from the general-purpose printing software 202, that is, in accordance with information that can be set for print setting. The capability information is also called print capabilities (hereinafter, referred to as “PC” in some cases). In a case where it is determined that the capability information includes information enabling display of the detailed setting screen 300C (information that causes the display of the setting reception screen 300C), the drawing application 201 causes the display 119 to display the detailed setting screen 300C. On the other hand, in a case where it is determined that the capability information does not include information enabling display of the detailed setting screen 300C, the drawing application 201 does not cause the display 119 to display the detailed setting screen 300C.

The general-purpose printing software 202 determines the PC on the basis of print function information 203. The print function information 203 is data indicating print functions, in which all settable print functions, setting values for the print functions, exclusion relationships among the setting values, and the like are described. The print function information 203 is also called print device capabilities (PDC). The print function information 203 is included in a configuration file of the general-purpose printing software 202 and is stored in the storage device 114 as an unchangeable file.

Alternatively, the print function information 203 is dynamically generated by the general-purpose printing software 202. Specifically, the general-purpose printing software 202 acquires attribute data on the printing apparatus 102 from the printing apparatus 102. The general-purpose printing software 202 generates the print function information 203 according to the attribute information in the attribute data. It should be noted that in a case where the print function information 203 is dynamically generated in this manner, the print function information 203 is editable.

The attribute data on the printing apparatus 102 is a response acquired by issuing an IPP “Get-Printer-Attributes” operation to the printing apparatus 102. The response includes functions that can be designated for the printing apparatus 102, that is, attribute information indicating the capabilities of the printing apparatus 102, and setting values related to the attribute information. Also, the response is saved in the RAM 113.

With such a configuration, the general-purpose printing software 202 allows a user to designate a print function available in the printing apparatus 102 in accordance with the printing apparatus 102 connected to the host computer 101. In this manner, a user can designate the print function available in the connected printing apparatus regardless of the model of the printing apparatus connected to the host computer 101, that is, even in a case where a printing apparatus having a function different from that of the printing apparatus 102 or developed by a different printer manufacturer is connected to the host computer 101.

It should be noted that the general-purpose printing software 202 is configured to use an “IPP Class Driver” installed in Windows (registered trademark) 11 in the present embodiment. The “IPP Class Driver” is a printer driver that executes printing processing in accordance with a standard printing protocol specification called IPP and is included in the OS package. The “IPP class driver” is not a unique printer driver for a particular model of printing apparatus and is a standard class driver that can be commonly used with printing apparatuses from various printer manufacturers. Furthermore, the “IPP Class Driver” acquires capability information on the printing apparatus 102 and generates the print function information 203 on the basis of the capability information.

The general-purpose printing software 202 can be associated with the extension application 204. In this manner, it is possible to provide functions that are not included in the general-purpose printing software 202. For example, the IPP Class Driver (general-purpose printing software 202) is not configured to provide a two-color print function, that is, the IPP Class Driver is not compatible with execution of the two-color printing processing.

The “two-color print function” is a function of executing two-color printing processing (color reduction processing). The two-color printing processing (color reduction processing) is processing of reducing the kinds of colors included in print data, which is targeted for printing by the printing apparatus 102, to two kinds (or two or more kinds) of colors and of causing the printing apparatus 102 to print the resulting print data. The two-color print function is a unique function that is compatible with printing apparatuses manufactured by specific printer manufacturers. In the present embodiment, the IPP Class Driver is not configured to execute the two-color print function and the extension application 204 executes the two-color print function as an extended function. However, the operation of the IPP Class Driver and the extension application 204 is not limited thereto. For example, the IPP Class Driver may be configured to execute a part of the two-color print function, and the extension application 204 may compensate for the shortage of the two-color print function to further extend the functions that the IPP Class Driver can execute.

In the present embodiment, it is assumed here that colors of input data are represented by RGB data composed of three commonly used RGB channels and each of the R value, the G value, and the B value takes a value of 0 to 255 of 8 bits, but the colors are not limited thereto. As described above, the two-color print function is a function of reducing the kinds of colors included in print data, which is targeted for printing by the printing apparatus 102, to predetermined two colors and of causing the printing apparatus 102 to print the resulting printing data in the two colors.

In one case of specifying two colors to be used for the two-color print function, a plurality of combinations of two colors may be set in advance, for example, and the two colors to be used may be specified by a user selecting a desired combination from the combinations. In another case, the two colors used in the two-color print function may be specified by a user selecting a mode for the two-color printing processing. Modes that can be selected by the user in this case include, for example, a “mode 1” (a first mode) and a “mode 2” (a second mode) in the present embodiment, but the modes are not limited thereto. The mode 1 and the mode 2 will be described later.

It should be noted that a color with an RGB value of (255, 255, 255) is defined as white, a color with an RGB value of (128, 128, 128) is defined as gray, and a color with an RGB value of (0, 0, 0) is defined as black in the present embodiment. Colors that have equal values for all components of RGB values, such as white, gray, and black are defined as achromatic colors while the other colors are defined as chromatic colors in the present embodiment, definitions of achromatic colors and chromatic colors are not limited thereto.

In the present embodiment, a description is given of cases where the printing apparatus 102 executes printing by the two-color print function. When a printed matter is created, two-color printing may be performed to create the printed matter with a relatively good visual impression, for example. However, the visual preference for colors in a printed matter differs depending on a person viewing the printed matter. Preferred colors may also differ depending on a person viewing an image, or an environment where the image is viewed, particularly in cases of photograph images, images including graphics, and office document images in which objects such as photographs and graphs are arranged like presentation materials. Therefore, it is preferable that the two-color print function is executed in accordance with the conditions.

Here, the “mode 1” and the “mode 2” used in the present embodiment will be described with reference to FIGS. 2C to 2H. FIGS. 2C to 2F are diagrams for explaining an execution example of the two-color print function. FIGS. 2G to 2H are flowcharts illustrating execution processing of the two-color print function.

The “mode 1” is a mode in which all chromatic colors from among all colors in print data are converted (unified) into one desired (predetermined) chromatic color regardless of the kinds of the chromatic colors while achromatic colors are left as the achromatic colors regardless of the kinds of the achromatic colors. Here, it is assumed that two-color printing using green and black is performed as an example of the two-color printing. In this case, all the chromatic colors from among all the colors in the print data are converted into green while the achromatic colors are left as the achromatic colors as an example of the mode 1.

Execution of the two-color print function in the mode 1 will be described with reference to FIGS. 2C, 2D, and 2G. As illustrated in FIG. 2C, print data 901 includes a text 902, a text 903, an object 904, and an object 905. The text 902 is a text “TEXT” in black. The text 903 is a text “TEXT” in yellow. The object 904 is an object “sun” in red. The object 905 is an object “mountain” in green.

As illustrated in FIG. 2D, in the lookup table 906, a color with RGB values of (0, 0, 0) is defined as black. In addition, a color with RGB values of (255, 0, 0) is defined as red, a color with RGB values of (0, 255, 0) is defined as green, and a color with RGB values of (255, 255, 0) is defined as yellow. In the present embodiment, CMYK values are defined such that when each of CMYK values is “0”, the brightness is the highest, and when each of CMYK values is “255”, the brightness is the lowest, but the definition is not limited thereto. Here, a color with CMYK values of (255, 0, 255, 0) is green, and a color with CMYK values of (0, 0, 0, 255) is black.

As illustrated in FIG. 2G, the printing apparatus 102 converts the print data 901 into an 8-bit image data including four channels of C (cyan), M (magenta), Y (yellow), and K (black) using the lookup table 906 in step S1701A.

In step S1702A, the printing apparatus 102 determines whether or not setting for the number of print colors set in the print data 901 is “two-color printing”. In a case where it is determined that the setting is the “two-color printing” as a result of the determination in step S1702A, the processing proceeds to step S1703A. On the other hand, in a case where it is determined that the setting is not the “two-color printing” as a result of the determination in step S1702A, the processing is ended.

In step S1703A, the printing apparatus 102 uses, for the print data 901 converted into CMYK data, the two-color conversion expression represented as Expression (1) below, and generates print data 907 including two colors. It should be noted that two-color printing using green and black is performed as an example of the two-color printing as described above. In addition, parameters of Expression (1) differ depending on the two colors into which colors are converted. Also, Expression (1) is an example, and the expression is not limited thereto.

$$[ \begin{matrix}C \\ M \\ Y \\ K\end{matrix} ] = [ \begin{matrix}0.5 & 0.7 & 0.3 & 0 \\ 0 & 0 & 0 & 0 \\ 0.5 & 0.7 & 0.3 & 0 \\ 0 & 0 & 0 & 1\end{matrix} ] \times [ \begin{matrix}C \\ M \\ Y \\ K\end{matrix} ] \qquad ( 1 )$$

It is assumed that the maximum value of each component of CMYK calculated by Expression (1) is 255. The yellow text 903 in FIG. 2C is converted into a green text 908, and the red object 904 is converted into a green object 909, by Expression (1). The color of the text 902 is left as black and the color of the object 905 is left as green. In this manner, the print data 907 including two colors of green and black is generated after the two-color conversion.

The “mode 2” is a mode in which one chromatic color (predetermined color) and colors similar to the one chromatic color from among all colors in the print data are converted (unified) into the one chromatic color while the other colors are converted into an achromatic color (another predetermined color). Here, it is assumed that two-color printing using green and black is performed as an example of the two-color printing. In other words, green and colors similar to green from among all the colors in the print data are converted into green, and the other colors are converted into black as an example of the mode 2.

Execution of the two-color print function in the mode 2 will be described with reference to FIGS. 2E, 2F, and 2H. As illustrated in FIG. 2E, the print data 901 includes a black text 902, a yellow text 903, a red object 904, and a green object 905 similarly to FIG. 2C.

As illustrated in FIG. 2F, in a lookup table 910, a color with RGB values of (0, 0, 0) is defined as black, a color with RGB values of (255, 0, 0) is defined as red, a color with RGB colors of (0, 255, 0) is defined as green, and a color with RGB colors of (255, 255, 0) is defined as yellow, similarly to FIG. 2D. Furthermore, HSV values can be calculated from RGB values, for example, (0, 255, 0) which are the RGB values of green. The HSV values are values of a color space represented by Hue (hue), Saturation Chroma (saturation), and Value Brightness (brightness). Since this calculation method is publicly known, description thereof will be omitted. In a case where a calculated value of the H (hue) component is 120 (value range: 0 to 360), for example, colors with RGB values for which a value of an H component is within a range of 100 to 140 are defined as similar colors. Then, a lookup table is used such that CMYK values of the similar colors are set to (255, 0, 255, 0) and CMYK values of the other colors are set to (0, 0, 0, 255). This makes it possible to generate print data 911 including two colors. It should be noted that the lookup table 910 is just an example and is not limited thereto. In addition, the values in the lookup table 910 differ depending on the two colors into which colors are converted.

As illustrated in FIG. 2H, in step S1701B, the printing apparatus 102 determines whether or not the setting for the number of print colors set in the print data 901 is “two-color printing” similarly to step S1702A (see FIG. 2G). In a case where it is determined that the setting is the “two-color printing” as a result of the determination in step S1701B, the processing proceeds to step S1702B. On the other hand, in a case where it is determined that the setting is not the “two-color printing” as a result of the determination in step S1701B, the processing proceeds to step S1703B.

In step S1702B, the printing apparatus 102 uses the lookup table 910 for the print data 901 to generate two-color print data 911 in which each component of CMYK is 8 bits, and then the processing is ended. The yellow text 903 is converted into a black text 912, and the red object 904 is converted into the black object 913, through two-color conversion processing using the lookup table 910. The color of the text 902 is left as black and the color of the object 905 is left as green. In this manner, the print data 911 including two colors of green and black, is generated after two-color conversion.

In step S1703B, the printing apparatus 102 converts the print data 901 into an 8-bit image data using the lookup table 906 similarly to step S1701A (see FIG. 2G), and the processing is ended. In the mode 2, it is possible to convert only colors similar to a designated color into green unlike the mode 1. In this manner, it is possible to generate the print data 911 in which the green object 905 is more emphasized.

Here, description returns to the referring to FIG. 2A. The OS generates intermediate data (referred to as “input data” in some cases) on the basis of a print instruction output from the drawing application 201 and transmits the intermediate data to the general-purpose printing software 202. The data output by the drawing application 201 for printing is not particularly limited and is preferably, for example, data in a Graphic Device Interface format (GDI format). Alternatively, the data output by the drawing application 201 for printing may be data in an XML Paper Specification format (XPS format).

In a case where an IPP Class Driver is used as the general-purpose printing software 202 and the data output by the drawing application 201 is GDI format data, the OS converts the GDI format data into XPS format data. Then, the OS transmits the converted XPS format data as intermediate data to the general-purpose printing software 202.

In another case where the data output by the drawing application 201 is XPS format data, the OS transmits the XPS format data as the intermediate data to the general-purpose printing software 202. It should be noted that the intermediate data includes drawing data that is information such as text and figures to be formed on a print medium, and print setting information set by a user.

The general-purpose printing software 202 converts the intermediate data into print data (image data) that can be processed, that is, that can be printed by the printing apparatus 102, and then transmits the print data to the printing apparatus 102. Here, the “print data” in the present embodiment is Page Description Language (PDL) data conforming to IPP. The PDL data is, for example, data in a Portable Document Format (PDF) or a PWG-Raster format. The print data includes drawing data that is information on text and figures to be formed on the print medium, and print setting attribute information that is generated on the basis of print setting information set by a user and designates print settings. The print setting attribute information includes attribute information and setting values related to the attribute information, where the attribute information indicates functions of the printing apparatus 102 that can be designated, that is, capabilities of the printing apparatus 102.

The printing apparatus 102 performs printing on a print medium on the basis of the print data sent from the general-purpose printing software 202. At this time, the printing apparatus 102 forms the drawing data included in the print data on the print medium by performing an operation in accordance with the print setting attribute information included in the print data. The print setting attribute information includes, for example, a print quality level such as priority on image quality or priority on a speed, attribute information for designating double-sided printing or one-side printing, and setting values of the attribute information. In a case where the print setting attribute information includes attribute information designating double-sided printing, for example, it causes the printing apparatus 102 to execute double-sided printing.

A software configuration of the printing system 1000 in a case where the extension application 204 is associated with the general-purpose printing software 202 and the printing apparatus 102 will be described with reference to FIG. 2B. As illustrated in FIG. 2B, the extension application 204 has been added to the software configuration of the printing system 1000 unlike FIG. 2A. In other words, the host computer 101 includes the drawing application 201, the general-purpose printing software 202, and the print function information 203, and further includes the extension application 204.

The extension application 204 is software for extending the functions of the general-purpose printing software 202. The extension application 204 is not included (not packaged) in the OS in advance. Therefore, the extension application 204 is downloaded from a server (which is not illustrated) via the Internet and installed in the host computer 101, by a user operating the host computer 101.

Alternatively, when the printing apparatus 102 is connected to the host computer 101, the extension application 204 may be automatically installed in the host computer 101 on the basis of the connection. Specifically, when the printing apparatus 102 is connected to the host computer 101, device identification information is acquired from the printing apparatus 102 by the OS. The extension application 204 corresponding to the device identification information may be downloaded from a server via the Internet and installed in the host computer 101 by the OS. As a result, the general-purpose printing software 202 and the extension application 204 are held as mutually different control programs in the host computer 101.

The general-purpose printing software 202 and the extension application 204 may be updated and upgraded. The updating processing of the general-purpose printing software 202 and the updating processing of the extension application 204 in this case may be performed at the same timing or may be performed at different timings.

A trigger due to which the general-purpose printing software 202 is acquired by the host computer 101 and a trigger due to which the extension application 204 is acquired may be the same trigger or may be different triggers. When the extension application 204 is installed in the host computer 101, the extension application 204 is associated with the general-purpose printing software 202 and the printing apparatus 102 by the OS.

As illustrated in FIG. 2B, the extension application 204 is configured to exchange information (transmit and receive information) with the general-purpose printing software 202 and the printing apparatus 102. In other words, the extension application 204 is associated with the general-purpose printing software 202 and the printing apparatus 102.

In the present embodiment, the extension application 204 includes a print setting screen extension unit 205, a print function extension unit 206, an intermediate data editing unit 207, and a notification unit 209. Also, the extension application 204 includes shared information 208 that can be accessed by the print setting screen extension unit 205, the print function extension unit 206, the intermediate data editing unit 207, and the notification unit 209. The shared information 208 is a file saved in the storage device 114 or information stored in the RAM 113. The extension application 204 is configured to write and read the shared information 208 by using an Application Program Interface (API) provided by the OS.

The extension application 204 may end the operation of the entire extension application 204 along with an end of processing of each of the units including the print setting screen extension unit 205 to the notification unit 209. In this case, the OS activates the extension application 204 every time a processing execution request of each unit is received. Furthermore, the OS causes the operation of the entire extension application 204 to end when the processing of the print setting screen extension unit 205 ends, for example.

The extension application 204 may cancel the processing of each of the units including the print setting screen extension unit 205 to the notification unit 209 during the processing. In this case, a job that is being processed in a print queue is deleted by the OS. As described above, the drawing application 201 issues a print instruction to the OS in response to receiving a print request from a user.

The drawing application 201 is configured to cause the display 119 to display a print setting screen. In the configuration illustrated in FIG. 2B, the drawing application 201 is configured to cause the display 119 to display a print setting screen 300A (furthermore, a detailed setting screen 300C as needed) provided by the print setting screen extension unit 205 (extension application 204). Further, the print setting screen extension unit 205 is configured to save detailed settings set by a user in the shared information 208. Details of the print setting screen extension unit 205 will be described later.

The intermediate data editing unit 207 acquires intermediate data from the general-purpose printing software 202. Then, the intermediate data editing unit 207 converts the intermediate data into print data and then transmits the print data to the printing apparatus 102. Furthermore, the intermediate data editing unit 207 acquires detailed setting information from the shared information 208 and adds the detailed setting to the print data. The printing apparatus 102 performs printing on a paper surface on the basis of the print data from the intermediate data editing unit 207. Alternatively, the extension application 204 may be configured to acquire print data generated by the general-purpose printing software 202 and add detailed settings to the print data. It should be noted that, even with the configuration of FIG. 2B, the two-color print function may not be executed in some cases. In this case, the general-purpose printing software 202 may transmit the print data to the printing apparatus 102 without intervention of the extension application 204.

The print function extension unit 206 is configured to edit print function information 203 (PDC) generated by the general-purpose printing software 202 or the OS. In this manner, it is possible to add the function provided by the extension application 204 to the print function information 203. Furthermore, it is also possible to add processing (for example, processing of the two-color print function) that can be executed by the printing apparatus 102 but cannot be executed by the general-purpose printing software 202 to the print function information 203, and to add exclusion relationships among setting values for the print function to the print function information 203.

The OS activates the print function extension unit 206 when the extension application 204 is first associated with the printing apparatus 102 and the general-purpose printing software 202. Alternatively, the OS may activate the print function extension unit 206 at another timing (when the OS is activated, for example). Through such activation, even in a case where a function related to printing is extended later, the print function extension unit 206 can detect the extended function and adds the extended function to the print function information 203. Examples of situations where a function related to printing is expanded later include adding an optional device (such as a finisher) to the printing apparatus 102 later.

The notification unit 209 is configured to, when an error occurs in the printing apparatus 102, provide a notification indicating the fact. In a case where an error of no paper occurs in the printing apparatus 102, for example, the general-purpose printing software 202 detects the occurrence of the error. The OS uses a notification function called a toast notification, which is one of functions of the OS, to cause the display 119 to display a message indicating the occurrence of the error of no paper as a result of the detection of the general-purpose printing software 202. It should be noted that when a user operates the toast notification, the notification unit 209 is invoked by the OS, and a user interface screen (UI screen) of the notification unit 209 is displayed on the display 119. The user interface screen is configured to indicate a detailed message related to the error of no paper and a method of refilling paper, for example.

As described above, it is can be stated that the extension application 204 has the following four functions in the present embodiment. The first function is a function of displaying a setting screen on the display 119. This function is executed by the print setting screen extension unit 205. The second function is a function of editing intermediate data, converting the intermediate data into print data, and adding detailed settings to the print data. This function is executed by the intermediate data editing unit 207. The third function is a function of extending a function that can be designated by the printing data generation software. This function is executed by the print function extension unit 206. The fourth function is a function of displaying a screen on the display 119 in response to occurrence of an error in the printing apparatus 102. This function is executed by the notification unit 209.

It should be noted that the configuration of the extension application 204 is not limited to the configuration having these four functions, and is preferably a configuration having at least one function, and may be a configuration having yet other functions in addition. Furthermore, once the print data is transmitted to the printing apparatus 102, the extension application 204 cannot display on the display 119 a screen such as a guidance or the like linked to the print data in the course of the processing of the above-described units.

FIGS. 3A to 3D are diagrams illustrating examples of screens displayed on the display 119 of the printing system 1000. FIG. 3A illustrates a print setting screen displayed on the display 119 by the drawing application 201. FIG. 3B illustrates a detailed setting screen displayed on the display 119 in a case of a configuration in which the extension application 204 is not associated with the general-purpose printing software 202 and the printing apparatus 102. FIG. 3C illustrates a detailed setting screen displayed on the display 119 in a case of a configuration in which the extension application 204 is associated with the general-purpose printing software 202 and the printing apparatus 102. It should be noted that a software unit and a module to display the screens are not particularly limited. For example, the print setting screen extension unit 205 may be configured only to generate a display screen. In such a case, the print setting screen extension unit 205 may transmit the generated display screen to the drawing application 201 via the general-purpose printing software 202. The drawing application 201 may be configured to display the acquired display screen on a display device such as the display 119.

The print setting screen 300A illustrated in FIG. 3A is a screen that allow a user to set print conditions related to printing by the printing apparatus 102. The print setting screen 300A includes a control (button) 301, a control 302, a control 303, a control 304, and a control 305.

With the control 301, a user is allowed to set the printing apparatus 102 to be used for printing, an orientation of printing in the printing apparatus 102, and the number of copies to be printed by the printing apparatus 102. In FIG. 3A, the printing apparatus 102 to be used for printing is set as a “printer 200a”, the orientation of printing in the printing apparatus 102 is set as “portrait”, and the number of copies to be printed by the printing apparatus 102 is set as “1” as an example. With the control 302, a preview screen is indicated. With the control 303, a user is allowed to provide an instruction to start printing by the printing apparatus 102. With the control 304, a user is allowed to provide an instruction to cancel the printing by the printing apparatus 102. With the control 305, a user is allowed to make detailed settings.

The detailed setting screen 300B illustrated in FIG. 3B is displayed on the display 119 when the control 305 is operated in the configuration in which the extension application 204 is not associated with the printing apparatus 102 and the general-purpose printing software 202. The detailed setting screen 300B includes a control 306, a control 307, a control 308, and a control 309.

With the control 306, a user is allowed to select and set the type of paper used for printing by the printing apparatus 102. In FIG. 3B, “plain paper” has been selected as an example. With the control 307, a user is allowed to select and set the size of paper used for printing by the printing apparatus 102. In FIG. 3B, “A4” has been selected as an example. With the control 308, a user is allowed to select a paper feed port for the paper used for printing by the printing apparatus 102. In FIG. 3B, “Automatic” has been selected as an example. With the control 309, a user is allowed to end setting operation using the control 306 to the control 308. Furthermore, the screen is returned to the print setting screen 300A illustrated in FIG. 3A when the control 309 is operated.

The detailed setting screen 300C (the setting reception screen that receives a setting for color reduction processing) illustrated in FIG. 3C is displayed on the display 119 when the control 305 is operated in the configuration in which the extension application 204 is associated with the printing apparatus 102 and the general-purpose printing software 202 (display control process). It should be noted that the detailed setting screen 300C is a screen displayed along with the print setting screen 300A, and the manner of display is not particularly limited. For example, the detailed setting screen 300C may be displayed in an overlapping manner on the print setting screen 300A, the detailed setting screen 300C may be displayed side-by-side with the print setting screen 300A, or the detailed setting screen 300C may be displayed after the print setting screen 300A disappears once.

The detailed setting screen 300C includes the control 306, the control 307, the control 308, and the control 309 similarly to the detailed setting screen 300B. Furthermore, the detailed setting screen 300C includes a control 310, a control 311, and a control 312 that receive various kinds of settings for the two-color print function.

With the control 310, a user is allowed to set the number of print colors to be reproduced in a printed matter. A list (which is not illustrated) including options of “full-color printing”, “one-color printing”, and “two-color printing”, for example, is displayed on the detailed setting screen 300C to allow a user to select one option from among these options, when the control 310 is operated. In a case where “full-color printing” is selected, the print colors to be reproduced in a printed matter is all the print colors. In a case where “one-color printing” is selected, the number of print colors to be reproduced in the printed matter is one. In a case where “two-color printing” is selected, the number of print colors to be reproduced in the printed matter is two. In the present embodiment, the control 310 is an execution selecting part that selects, as a setting for the two-color print function, whether or not to execute the two-color print function (color reduction processing). It should be noted that “two-color printing” has been selected as an example in FIG. 3B.

With the control 311, a user is allowed to select a mode for the two-color printing in a state where “two-color printing” has been selected by the control 310. A list (which is not illustrated) including options of the “mode 1” and the “mode 2” is displayed on the detailed setting screen 300C to allow a user to select one option from among these options, when the control 311 is operated. The aforementioned two-color conversion processing in the mode 1 is executed in a case where the “mode 1” is selected. The aforementioned two-color conversion processing in the mode 2 is executed in a case where the “mode 2” is selected. In the present embodiment, the control 311 is a switching part that switches the mode for two-color printing, as a setting for the two-color print function, between the mode 1 and the mode 2. It should be noted that the “mode 1” has been selected as an example in FIG. 3B. The control 311 is grayed out in a state where “two-color printing” has not been selected by the control 310. In this manner, the operation of the control 311, that is, the selection of the mode is inhibited.

The control 312 is a color designating part that designates two colors to be reproduced in the mode selected by the control 311, that is, two colors to be used in the two-color print function (the color reduction processing). The list 313 is displayed on the detailed setting screen 300C when the control 312 is operated (see FIG. 3D). The list 313 includes “black/red”, “black/green”, “black/blue”, “black/cyan”, “black/magenta”, and “black/yellow”. It should be noted that “black/red” has been selected as an example in FIG. 3D. In the present embodiment, a plurality of combinations of two colors to be reproduced in the two-color printing is set in advance, and the color designating part allows a user to select one from the plurality of combinations in accordance with a purpose of use of a printed matter, for example. In a case where the printing apparatus 102 is configured to print with ink or toner, options displayed in the list 313 may be grayed out in accordance with the amount of remaining ink or toner. When the amount of remaining yellow ink or toner is insufficient for printing, for example, the “black/yellow” option may be grayed out. In this manner, selection of “black/yellow” is inhibited.

Here, a reason that items included in the detailed setting screen 300B illustrated in FIG. 3B are different from items included in the detailed setting screen 300C illustrated in FIG. 3C will be described. Each of the detailed setting screen 300B and the detailed setting screen 300C is generated on the basis of the print function information (capability information). As described above, the general-purpose printing software 202 is not compatible with the two-color print function. Therefore, it is not possible to add the two-color print function to the print function information merely by the general-purpose printing software 202. Also, the general-purpose printing software 202 cannot interpret the two-color print function included in the print function information even if the two-color print function is originally included in the print function information. Therefore, it is not possible to display the settings for the two-color print function on the detailed setting screen. Thus, the print function extension unit 206 adds a two-color print function to the print function information 203. Then, the print setting screen extension unit 205 causes the display 119 to display the detailed setting screen 300C with reference to the capability information. In this manner, the extension application 204 causes the detailed setting screen to indicate the settings for the two-color print function.

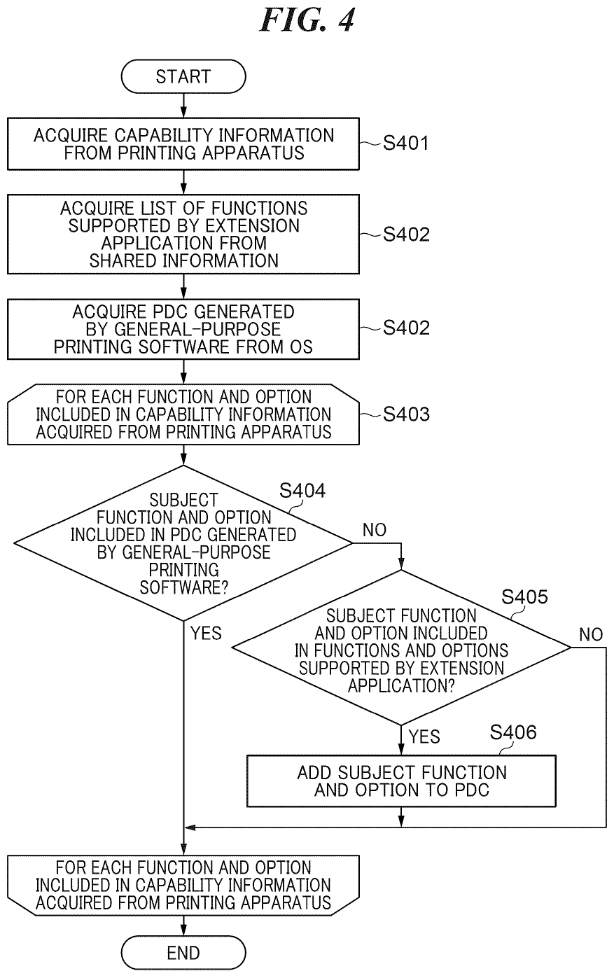

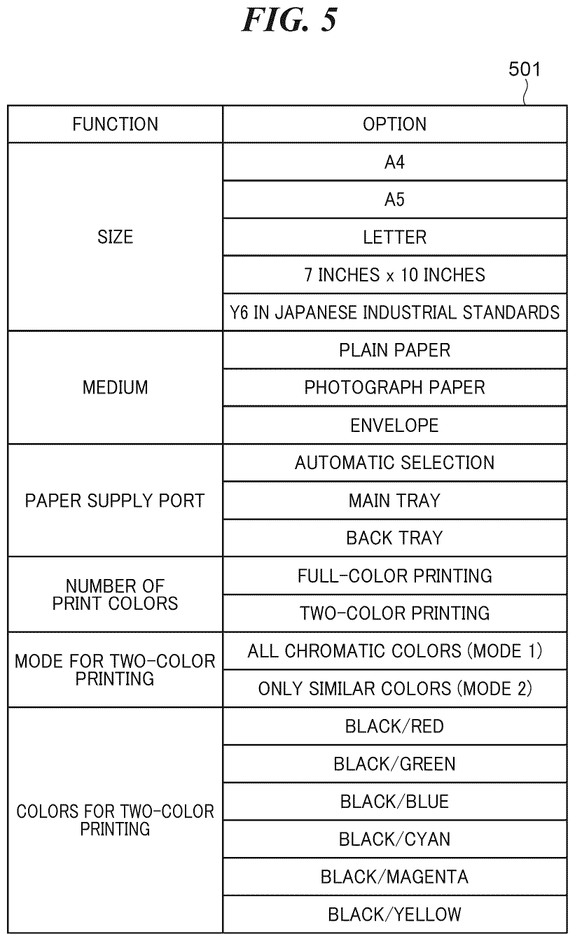

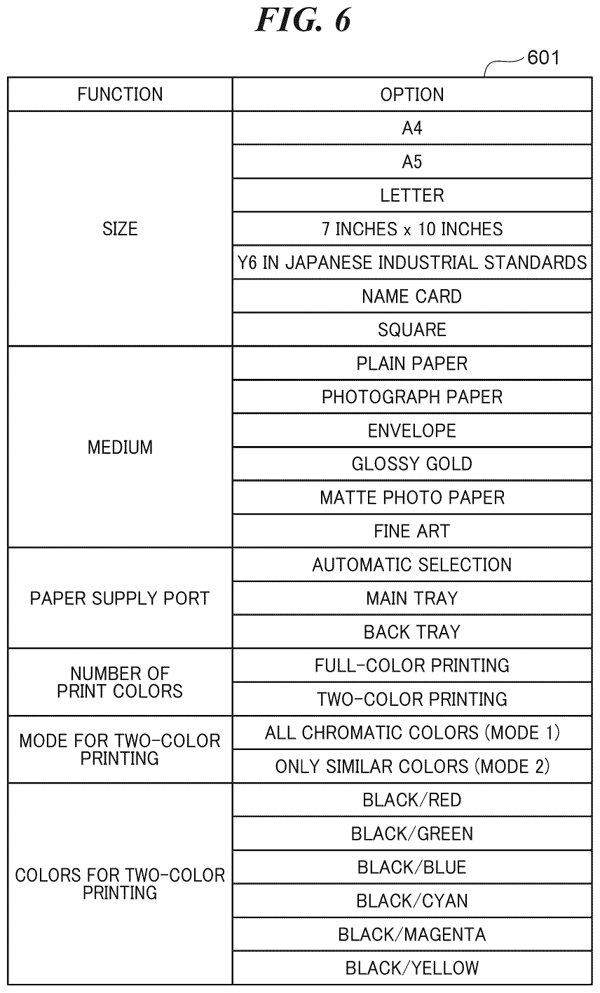

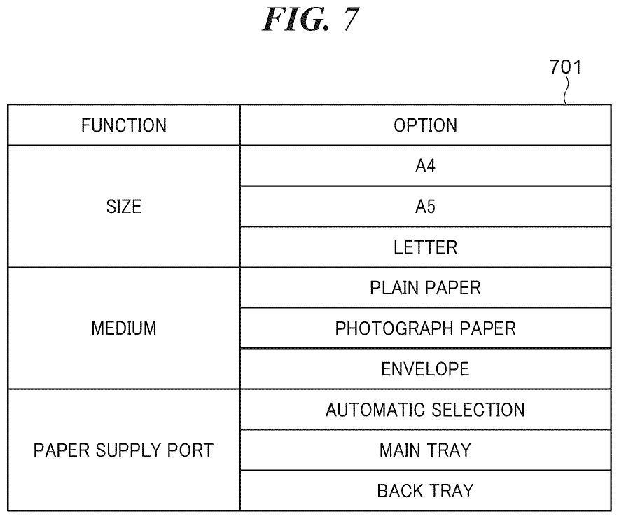

Hereinafter, processing in which the print function extension unit 206 edits the print function information will be described using FIGS. 4 to 7. FIG. 4 is a flowchart illustrating processing of editing the print function information by the print function extension unit 206. It should be noted that operations (steps) illustrated in the flowchart in FIG. 4 are implemented by the CPU 111 loading and executing the extension application 204 (print function extension unit 206) in the RAM 113. In addition, some operations such as data transmission and information input and output are implemented by the CPU 111 working with various interfaces in the host computer 101. In order to clarify a program that mainly works to implement the operations illustrated in the flowchart, software units such as the print function extension unit 206, applications, and the like will be described as grammatical subjects. FIG. 5 is a diagram illustrating an example of a list of capability information on the printing apparatus 102. FIG. 6 is a diagram illustrating an example of a list of print functions supported by the extension application 204. FIG. 7 is a diagram illustrating an example of a list of capability information of the general-purpose printing software 202.

As illustrated in FIG. 4, in step S401, the print function extension unit 206 acquires capability information from the printing apparatus 102 (acquisition process). The capability information indicates setting values included in a response acquired by issuing a “Get-Printer-Attributes” operation of IPP to the printing apparatus 102. The setting values are attribute information indicating functions that can be designated for the printing apparatus 102 and information related to the attribute information.

A table 501 in FIG. 5 presents a list of capability information on the printing apparatus 102. The capability information is information about the capabilities of the printing apparatus 102 to perform printing, and examples of the capability information include information about the sizes of paper available for printing by the printing apparatus 102. In addition, the list includes information about types of paper (medium) available for printing by the printing apparatus 102, information about paper feed ports for paper available for printing by the printing apparatus 102, and information about the color print functions (including two-color print function) executable by the printing apparatus 102. The information about the color print functions includes “full color printing” or the like that can be set by the control 310 described above, the “mode 1” or the like that can be set by the control 311, and “black/red” or the like that can be set by the control 312.

In step S402, the print function extension unit 206 acquires the print functions supported by the extension application 204 from the shared information 208. The shared information 208 stores a list of the print functions supported by the extension application 204. Also, this list includes all the print functions that can be processed by the extension application 204 and setting values for the print functions.

A table 601 in FIG. 6 presents information about sizes of paper supported by the extension application 204 as a print function. In addition, the table 601 presents information about the types of paper supported by the extension application 204, information about paper feed ports for paper supported by the extension application 204, and information about color print functions (including two-color print function) supported by the extension application 204. The information about the color printing functions includes “full-color printing” and the like that are similar to those in the table 501. Further, the print functions supported by the extension application 204 may be updated through updating or the like of the extension application 204.

In step S403, the print function extension unit 206 acquires the print function information 203 created by the general-purpose printing software 202 from the OS. The print function information 203 is created on the basis of the capability information acquired by the general-purpose printing software 202 from the printing apparatus 102.

The print function information 203 (PDC) created by the general-purpose printing software 202 includes only the print functions supported by the general-purpose printing software 202 in the capability information acquired from the printing apparatus 102. For example, although the table 601 in FIG. 6 includes “7 inches×10 inches” and “Y6 in Japanese industrial standards” as the paper sizes, the general-purpose printing software 202 does not support these paper sizes as is known from the table 701 in FIG. 7. Therefore, the print function information 203 does not include these paper sizes. Also, although the table 601 in FIG. 6 includes information about the color print functions (including two-color print function), the general-purpose printing software 202 does not support the two-color print function as is known from the table 701 illustrated in FIG. 7. Therefore, the print function information 203 does not include the two-color print function.

The extension application 204 compensates for the functions of the general-purpose printing software 202 by the print function extension unit 206 adding functions and options to the print function information 203. In addition, the print function extension unit 206 may also delete unnecessary functions and options from the print function information 203 created by the general-purpose printing software 202.

Steps S404, S405, and S406 are processes repeatedly performed for each item of the function list that the capability information acquired from the printing apparatus 102 in step S401 has. In the present embodiment, steps S404, S405, and S406 are repeatedly performed for each of all twenty one options included in the table 501.

In step S404, the print function extension unit 206 determines whether or not a function and an option that are being currently processed are included in the printing function information 203 generated by the general-purpose printing software 202. In a case where it is determined that the function and the option are included in the print function information 203 as a result of the determination in step S404, the print function extension unit 206 ends the processing if the last item in the options is being processed. If the last item in the options is not being processed, the print function extension unit 206 selects the next item in the options and executes step S404 again.

On the other hand, in a case where it is determined that the function and the option are not included in the print function information 203 as a result of the determination in step S404, the processing proceeds to step S405. For example, the table 501 includes the paper size “A4”, and the table 701 also includes the paper size “A4” in the present embodiment. In this case, it is determined in step S404 that the function and the option that are being currently processed are included in the print function information 203. On the other hand, the table 501 includes “full-color printing”, while the table 701 does not include “full-color printing”. In this case, it is determined in step S404 that the function and the option that are being currently processed are not included in the print function information 203.

In step S405, the print function extension unit 206 determines whether or not the function (option) that is being currently processed is included in the functions (options) supported by the extension application 204. In a case where it is determined that the function that is being currently processed is included in the functions (options) as a result of the determination in step S405, the processing proceeds to step S406. On the other hand, in a case where it is determined that the function that is being currently performed is not included in the functions (options) as a result of the determination in step S405, the print function extension unit 206 ends the processing if the last item in the options is being processed similarly to the case where the determination result is “Yes” in step S404. If the last item in the options is not being processed, the print function extension unit 206 selects the next item in the options and executes step S404 again. In a case where the function that is being currently processed is “full-color printing”, for example, “full-color printing” is also present in the table 601 in the present embodiment. Therefore, it is determined that the function that is being currently processed is included in step S405.

In step S406, the print function extension unit 206 adds the function (option) that is being currently performed to the print function information 203. After the execution of step S406, the print function extension unit 206 ends the processing if the last item in the options is being processed similarly to the case where the determination result in step S404 is “Yes”. If the last item in the options is not being processed, the print function extension unit 206 selects the next item in the options and executes step S404 again.

As described above, the extension application 204 adds, to the print function information 203, a function (option) that is not compatible with the general-purpose printing software 202, is compatible with the printing apparatus 102, and is compatible with the extension application 204. Then, the capability information (PC) is generated on the basis of the print function information 203 edited by the addition processing. Furthermore, the print setting screen extension unit 205 extends the function that is not compatible with the general-purpose printing software 202 and displays the detailed setting screen 300C illustrated in FIG. 3C on a display device such as the display 119 by generating the display screen on the basis of the capability information.

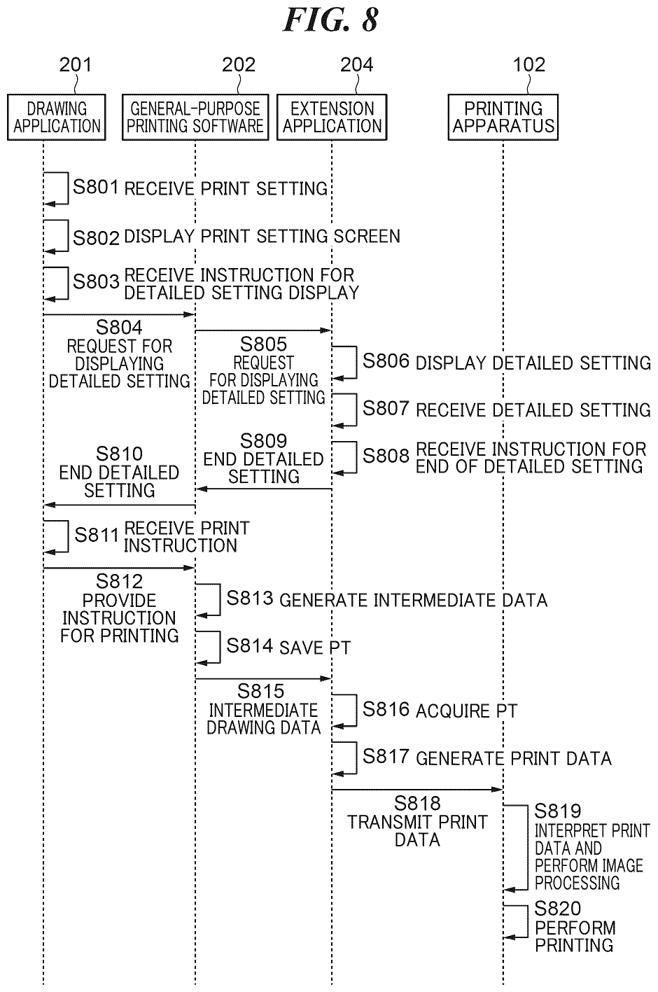

FIG. 8 is a sequence diagram illustrating processing executed among the drawing application 201, the general-purpose printing software 202, the extension application 204, and the printing apparatus 102 after the drawing application 201 receives print settings. The drawing application 201, the general-purpose printing software 202, and the extension application 204 are stored in the storage device 114, and the operations (steps) of the application and the software illustrated in the sequence diagram in FIG. 8 are implemented by the CPU 111 loading and executing these in the RAM 113 from the storage device 114. In addition, some operations such as data transmission and information input and output are implemented by the CPU 111 working with various interfaces in the host computer 101. In order to clarify a program that mainly works to implement the operations illustrated in the sequence diagram, software units, applications, and the like will be described as grammatical subjects. Also, the operation of the printing apparatus 102 is executed by a CPU (which is not illustrated) of the printing apparatus 102. Also, the software configuration of the printing system 1000 is the software configuration illustrated in FIG. 2B.

As illustrated in FIG. 8, the drawing application 201 receives print settings input by a user in step S801. The user is allowed to provide an instruction for print setting to the drawing application 201 by operating the pointing device 117 or the keyboard 118, for example.

In step S802, the drawing application 201 displays the print setting screen 300A illustrated in FIG. 3A on the display 119.

In step S803, the drawing application 201 receives a detailed setting instruction by the user. The user is allowed to provide an instruction for detailed settings by operating the pointing device 117 or the keyboard 118, for example, and perform selection operation on the control 305 on the print setting screen 300A.

In step S804, the drawing application 201 provides a request for displaying detailed settings to the general-purpose printing software 202.

In step S805, the general-purpose printing software 202 provides a request for displaying detailed settings to the extension application 204.

In step S806, the print setting screen extension unit 205 of the extension application 204 displays the detailed setting screen 300C in FIG. 3C on the display 119. As described above, the print function extension unit 206 adds the two-color print function to the print function information 203 (PDC). The print setting screen extension unit 205 is allowed to display the detailed setting screen 300C with reference to the capability information (PC) generated on the basis of the resulting print function information 203.

In step S807, the print setting screen extension unit 205 receives the detailed settings input by a user on the detailed setting screen 300C. Here, as an example, it is assumed that, on the detailed setting screen 300C, the paper type “plain paper” is selected with the control 306, the paper size “A4” is selected with the control 307, and the paper feed port “Automatic” is selected with the control 308 (see FIG. 3C). It is assumed that “two-color printing” has been selected with the control 310, the “mode 1” has been selected with the control 311, and “black/red” has been selected with the control 312 (see FIG. 3C). While these settings are made, the print setting screen extension unit 205 receives a user's operation of the control 309 on the detailed setting screen 300C.

In step S808, the print setting screen extension unit 205 receives an instruction to end the detailed setting operation by the user on the basis of the operation with the control 309 in step S807. The user is allowed to provide an instruction to end the detailed setting operation by operating the pointing device 117 or the keyboard 118, for example, and selecting the control 309.

In step S809, the extension application 204 transmits detailed setting end information indicating that the detailed settings in step S808 have been ended to the general-purpose printing software 202.

In step S810, the general-purpose printing software 202 receives the detailed setting end information transmitted from the extension application 204 in step S809. The general-purpose printing software 202 transmits the detailed setting end information to the drawing application 201.

In step S811, the drawing application 201 receives an instruction for printing by the user. The user is allowed to provide an instruction for printing by operating the pointing device 117 or the keyboard 118, for example, and selecting the control 303 on the print setting screen 300A (see FIG. 3A).

In step S812, the drawing application 201 provides an instruction for printing received in step S811 to the general-purpose printing software 202.

In step S813, the general-purpose printing software 202 generates intermediate data based on the print instruction in step S812 using modules of the OS.

In step S814, the general-purpose printing software 202 stores the print setting information (PT) based on the print instruction in step S812 in the shared information 208.

In step S815, the general-purpose printing software 202 transmits drawing data in the intermediate data generated in step S813 to the extension application 204.

In step S816, the intermediate data editing unit 207 of the extension application 204 acquires the print setting information saved in step S814 from the shared information 208.

In step S817, the intermediate data editing unit 207 of the extension application 204 generates print data using the drawing data transmitted in step S815 and the print setting information acquired in step S816. The print data is converted into data including the two-color print function settings received on the detailed setting screen 300C.

In step S818, the intermediate data editing unit 207 of the extension application 204 transmits the print data generated in step S817 to the printing apparatus 102 (transmission process). It should be noted that the print data includes the setting information for the two-color print function received on the detailed setting screen 300C. In other words, the setting information for the two-color print function (color reduction processing) received on the detailed setting screen 300C is transmitted to the printing apparatus 102.

In step S819, the printing apparatus 102 receives the print data transmitted in step S818. The printing apparatus 102 interprets the print data and performs necessary image processing on the print data. As the image processing here, the two-color print function (color reduction processing) using black and red is executed.

In step S820, the printing apparatus 102 prints the print data on which the image processing has been performed in step S819. In this manner, a two-color printed matter printed using black and red is obtained by the printing apparatus 102. In this printed matter, red is emphasized therein, for example, as compared with a case where the two-color print function is not executed.

As described above, according to the printing system 1000, the extension application 204 causes the printing apparatus 102 to execute the two-color print function even in a case where the general-purpose printing software 202 is not compatible with the two-color print function. In this manner, the printed matter on which the two-color printing has been performed (reflected) is obtained from the printing apparatus 102.

It should be noted that although the detailed setting screen 300C illustrated in FIG. 3C is displayed on the display 119 on the assumption that the printing system 1000 has the software configuration illustrated in FIG. 2B in the description referring to FIG. 8, the software configuration is not limited thereto. In a case where the request for displaying detailed settings is provided to the general-purpose printing software 202 in step S804, for example, the general-purpose printing software 202 displays the detailed setting screen 300B illustrated in FIG. 3B on the display 119. In this case, after the operation of the control 309 on the detailed setting screen 300B, the general-purpose printing software 202 provides a request for displaying the additional detailed setting screen on the display 119 to the extension application 204. Next, the extension application 204 may cause the display 119 to additionally display the detailed setting screen on which settings for the two-color print function is allowed to be made. Although the extension application 204 generates the print data from the intermediate data generated by the general-purpose printing software 202 in the present embodiment, the extension application 204 is not limited thereto, and the extension application 204 itself may generate the intermediate data, for example.

### Second Embodiment

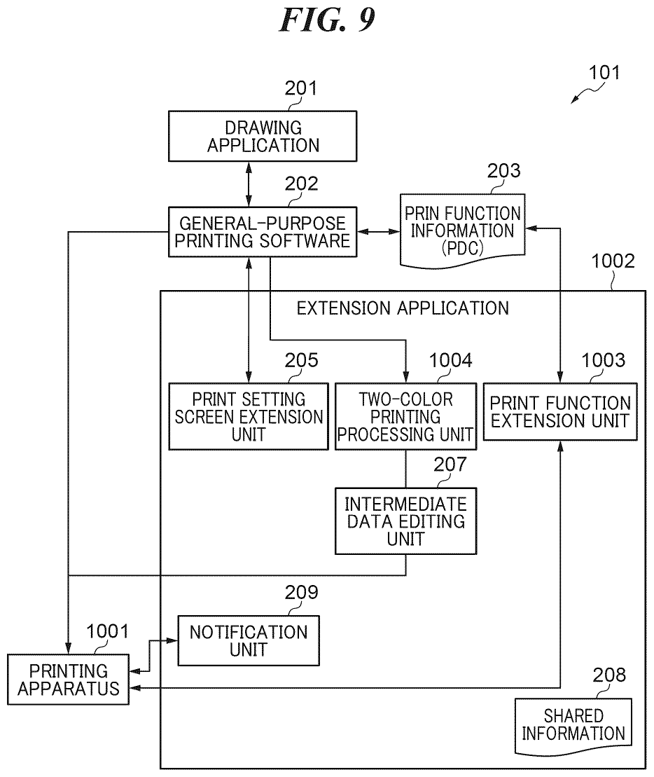

Although a second embodiment will be described below with reference to FIGS. 9 to 12, differences from the aforementioned embodiment will be mainly described, and description of similar matters will be omitted.

In the first embodiment, the extension application 204 works with the general-purpose printing software 202 to generate print data including settings for the two-color print function. The print data is transmitted to the printing apparatus 102. The printing apparatus 102 interprets the print data including the two-color print function settings and executes two-color printing processing. In this manner, the extension application 204 works with the general-purpose printing software 202 to cause the printing apparatus 102 to execute the two-color printing processing in the first embodiment.

However, some printing apparatuses are not configured to execute the two-color printing processing. In this case, it is not possible to cause such printing apparatus 102 to perform the two-color printing processing even if the extension application 204 generates print data including two-color print function settings. In a case where the printing apparatus 102 cannot execute the two-color printing processing, it is preferable that the extension application 204 generates print data on which the two-color printing processing (color reduction processing) has already been executed and transmits the print data to the printing apparatus 102.

In the present embodiment, a determination whether or not the two-color printing processing is executable on the printing apparatus is made on the basis of capability information on the printing apparatus. In a case where it is determined that the two-color printing processing is executable on the printing apparatus as a result of the determination, the extension application generates print data reflecting the two-color print function settings and then transmits the generated print data to the printing apparatus. On the other hand, in a case where it is determined that the two-color printing processing is not executable on the printing apparatus, the extension application generates print data prepared by executing the two-color printing processing on drawing data and then transmits the generated print data to the printing apparatus. In this manner, it is possible to provide the two-color print function to users even in a case where the printing apparatus cannot execute the two-color printing processing. It should be noted that the present embodiment is similar to the first embodiment other than a configuration of a printing system in a case where an extension application is associated with a printing apparatus and a general-purpose printing software, processing of editing PDC, and processing after a drawing application receives print setting.

FIG. 9 is a block diagram illustrating a software configuration of a printing system 1000 according to the second embodiment. The block diagram in FIG. 9 illustrates the software configuration of the printing system 1000 in a case where an extension application 1002 is associated with a general-purpose printing software 202 and a printing apparatus 1001. As illustrated in FIG. 9, a host computer 101 includes a drawing application 201, a general-purpose printing software 202, print function information 203, and the extension application 1002. The extension application 1002 is communicatively connected to the printing apparatus 1001. The printing apparatus 1001 is a printing apparatus that is not configured to execute two-color printing processing unlike the printing apparatus 102 according to the first embodiment.

The extension application 1002 includes a print setting screen extension unit 205, an intermediate data editing unit 207, a notification unit 209, a print function extension unit 1003, and a two-color printing processing unit 1004. The print function extension unit 1003 is configured to add a two-color print function to the print function information 203 even in a case where it is determined that the two-color printing processing is not executable on the printing apparatus 102 on the basis of capability information acquired from the printing apparatus 1001. The two-color printing processing unit 1004 performs two-color printing processing on intermediate data (drawing data) from the general-purpose printing software 202 on the basis of two-color print function settings set by a user.

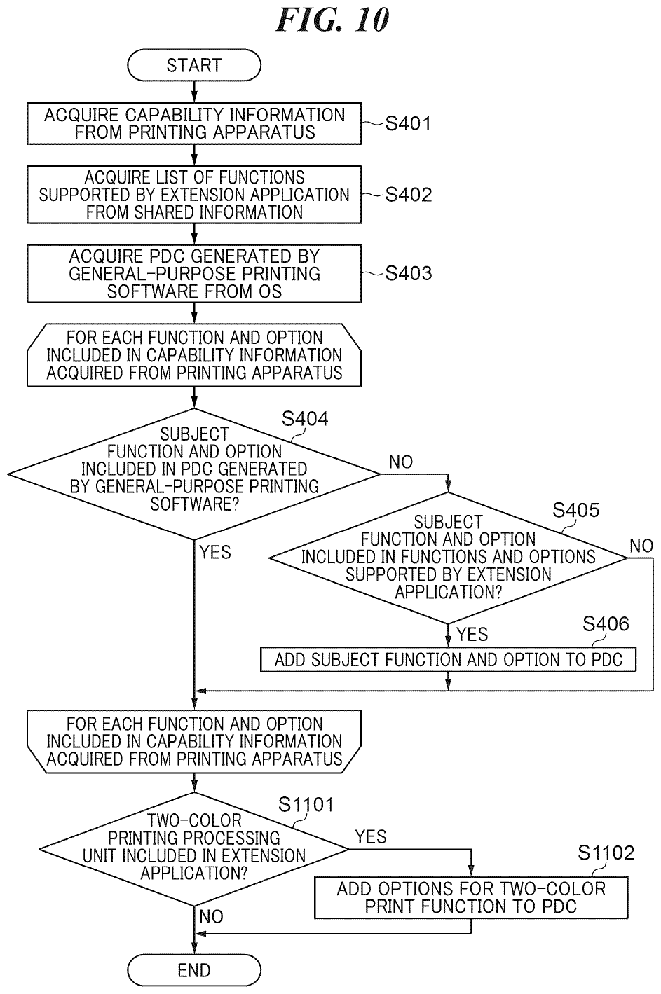

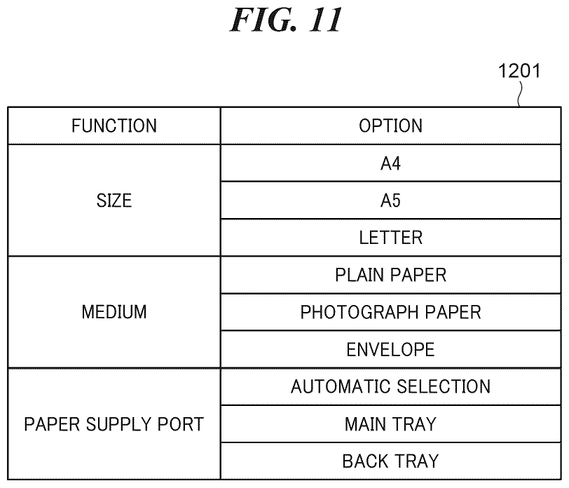

FIG. 10 is a flowchart illustrating processing of editing print function information by the print function extension unit 1003. It should be noted that operations (steps) illustrated in the flowchart in FIG. 10 are implemented by a CPU 111 loading and executing the extension application 1002 (print function extension unit 1003) in the RAM 113. In addition, some operations such as data transmission and information input and output are implemented by the CPU 111 working with various interfaces in the host computer 101. In order to clarify a program that mainly works to implement the operations illustrated in the flowchart, software units such as the printing function extension unit 1003, applications, and the like will be described as grammatical subjects. Also, the flowchart in FIG. 10 is a flowchart obtained by adding step S1101 and step S1102 to the flowchart in FIG. 4. FIG. 11 is a diagram illustrating an example of a list of capability information on the printing apparatus 1001.

As illustrated in FIG. 10, the processing proceeds to step S1101 in a case where repeated processing in steps S404 to S406 is ended. A table 1201 in FIG. 11 presents a list of capability information on the printing apparatus 1001. Although the table 1201 includes, as the capability information, information about sizes of paper, information about types of paper, and information about paper feed ports of paper, the table 1201 does not include information about the color print functions (two-color print function) unlike the table 501 in FIG. 5. Therefore, it is possible to ascertain that the printing apparatus 1001 cannot execute the two-color printing processing. Therefore, the two-color print function is not added to the print function information 203 after the processes of steps S404 to S406 are ended.

As illustrated in FIG. 10, in step S1101, the print function extension unit 1003 determines whether or not the two-color printing processing unit 1004 is included in the extension application 1002, that is, whether or not the two-color printing processing unit 1004 is present. In a case where it is determined that the two-color printing processing unit 1004 is present as a result of the determination in step S1101, the processing proceeds to step S1102. On the other hand, in a case where it is determined that the two-color printing processing unit 1004 is not present as a result of the determination in step S1101, the processing is ended. As described above, the extension application 1002 includes the two-color printing processing unit 1004, and the processing thus proceeds to step S1102.

In step S1102, the print function extension unit 1003 adds, to the print function information 203, all options such as “full-color printing” which is information about the color print functions (including two-color print function) in the table 601.

As described above, the extension application 1002 adds, to the print function information 203, a function (option) that is not compatible with the general-purpose printing software 202, is compatible with the printing apparatus 1001, and is compatible with the extension application 204. Then, the extension application 1002 determines whether or not the two-color printing processing unit 1004 is present. In a case where it is determined that the two-color printing processing unit 1004 is present as a result of the determination, the two-color print function is added to the print function information 203. The capability information is generated through the addition processing on the basis of the print function information 203 to which the two-color print function has been added, even in the case where the printing apparatus 1001 cannot execute the two-color printing processing. The extension application 1002 displays the detailed setting screen 300C illustrated in FIG. 3C on the display 119 by generating a display screen on the basis of the capability information.

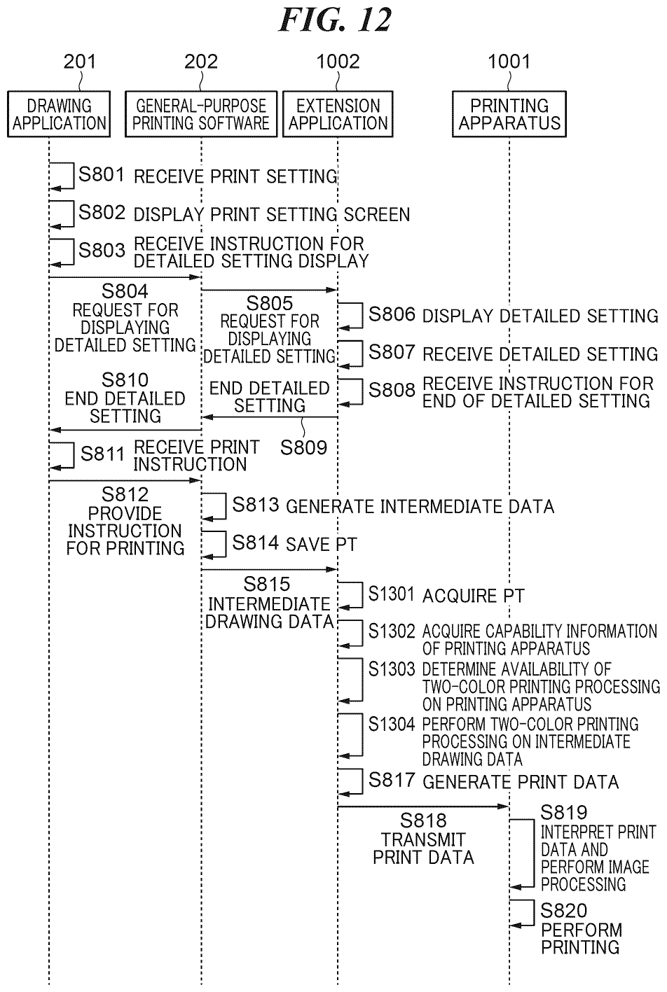

FIG. 12 is a sequence diagram illustrating processing executed among the drawing application 201, the general-purpose printing software 202, the extension application 1002, and the printing apparatus 1001 after the drawing application 201 receives print settings. The drawing application 201, the general-purpose printing software 202, and the extension application 1002 are stored in the storage device 114, and the operations (steps) of the application and the software illustrated in the sequence diagram in FIG. 12 are implemented by the CPU 111 loading and executing these in the RAM 113 from the storage device 114. In addition, some operations such as data transmission and information input and output are implemented by the CPU 111 working with various interfaces in the host computer 101. In order to clarify a program that mainly works to implement the operations illustrated in the sequence diagram, software units, applications, and the like will be described as grammatical subjects. The sequence diagram in FIG. 12 is a sequence diagram obtained by mainly adding steps S1301 to S1304 to the sequence diagram in FIG. 8.

As illustrated in FIG. 12, the processing proceeds to step S1301 after step S815 is executed. In step S1301, the two-color printing processing unit 1004 of the extension application 1002 acquires the print setting information (PT) saved in step S814 from the shared information 208. Furthermore, the two-color printing processing unit 1004 acquires information about the two-color print function setting included in the print setting information.

In step S1302, the two-color printing processing unit 1004 acquires the capability information on the printing apparatus 1001 from the shared information 208. It should be noted that in a case where the shared information 208 does not include the capability information on the printing apparatus 1001, the print function extension unit 1003 may provide a request for the capability information to the printing apparatus 1001. The capability information is saved in the shared information 208 in this case as well.

In step S1303, the two-color printing processing unit 1004 determines whether or not the two-color printing is executable on the printing apparatus 1001 on the basis of the capability information acquired in step S1302 (determination process). In other words, the two-color printing processing unit 1004 determines whether or not the capability information acquired in step S1302 includes information indicating that the printing apparatus 102 can execute the two-color printing processing (execution of the conversion processing, which is processing of converting data generated by the general-purpose program into the print data to be subjected to printing based on the color reduction processing with the setting for the color reduction processing received through the setting reception screen).

As described above, the printing apparatus 1001 is a printing apparatus that is not configured to perform the two-color printing processing in the present embodiment. Therefore, it is determined that the two-color printing processing is not executable on the printing apparatus 1001 as a result of the determination in step S1303. In a case where it is determined that the two-color printing processing is executable on the printing apparatus 1001 as a result of the determination in step S1303, step S1304 is omitted, and the processing proceeds to step S817. This is because the printing apparatus 1001 can perform the two-color printing processing at a higher speed than the two-color printing processing unit 1004. Specifically, this is because the printing apparatus 1001 can perform the processing at a higher speed than the two-color printing processing unit 1004 by an Application Specific Integrated Circuit (ASIC).

In step S1304, on the basis of the information about the two-color print function setting acquired in step S1301, the two-color printing processing unit 1004 executes the two-color printing processing on the intermediate drawing data, that is, converts the intermediate drawing data into print data that can be printed in two colors (conversion process). The processing result is saved in the shared information 208. Furthermore, the two-color printing processing unit 1004 deletes the information about the two-color print function setting from the print setting information.

After step S1304 is executed, steps S817 to S820 are executed in order. It should be noted that the print data transmitted in step S818 reflects the execution result obtained by executing the two-color printing processing in step S1304. Thus, the printed matter obtained in step S820 is a printed matter of print data on which the two-color printing processing has been executed.

As described above, in the present embodiment, the extension application 1002 (CPU 111) can execute the two-color printing processing even in a case where the printing apparatus 1001 cannot execute the two-color printing processing. In this manner, the printed matter of print data on which the two-color printing processing has been performed is obtained even from the printing apparatus 1001.

### Third Embodiment

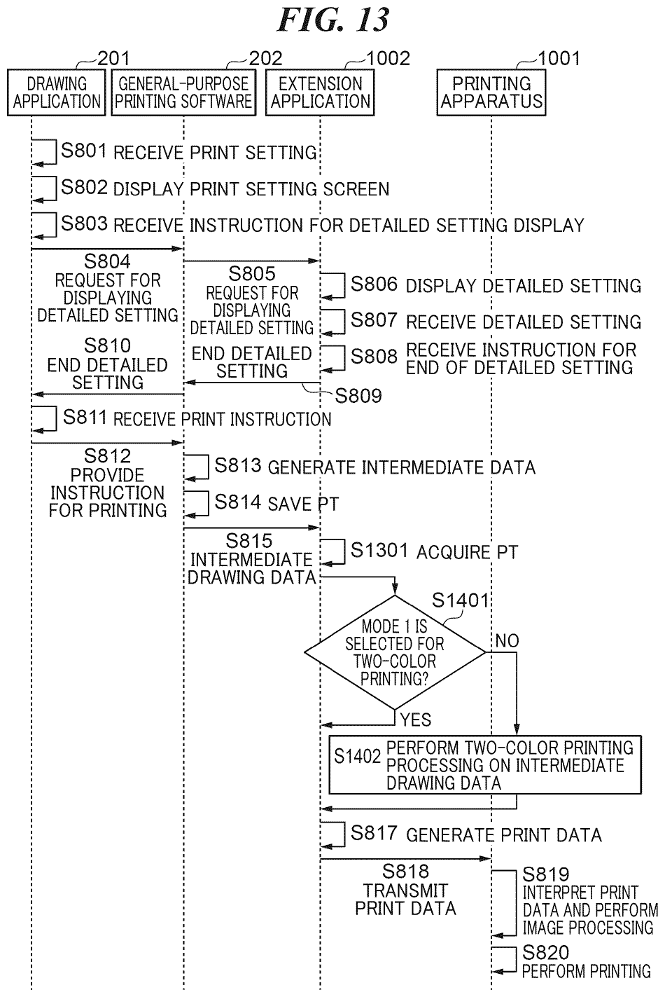

Although a third embodiment will be described below with reference to FIG. 13, differences from the aforementioned embodiments will be mainly described, and description of similar matters will be omitted.

The extension application 1002 is configured to perform the two-color printing processing in any of the mode 1 and the mode 2. On the other hand, some printing apparatuses 1001 may be configured to perform the two-color printing processing in the mode 1 out of the mode 1 and the mode 2, for example. In a case where the printing apparatus 1001 is equipped with a dedicated high-speed processing module to execute the two-color printing processing in the mode 1, it is more preferable that the printing apparatus 1001 executes the two-color printing processing in the mode 1 than the extension application 1002 does. In the present embodiment, a printing apparatus 1001 executes the two-color printing processing in the mode 1 in a case where the mode 1 is selected, and an extension application 1002 executes the two-color printing processing in the mode 2 in a case where the mode 2 is selected, as an example.

FIG. 13 is a sequence diagram illustrating processing executed among a drawing application 201, general-purpose printing software 202, an extension application 1002, and a printing apparatus 1001 after the drawing application 201 receives print settings in a printing system 1000 according to the third embodiment. The drawing application 201, the general-purpose printing software 202, and the extension application 1002 are stored in a storage device 114, and the operations (steps) of the application and the software illustrated in the sequence diagram in FIG. 13 are implemented by a CPU 111 loading and executing these in a RAM 113 from the storage device 114. In addition, some operations such as data transmission and information input and output are implemented by the CPU 111 working with various interfaces in the host computer 101. In order to clarify a program that mainly works to implement the operations illustrated in the sequence diagram, software units, applications, and the like will be described as grammatical subjects. The sequence diagram in FIG. 13 is a sequence diagram obtained by mainly adding steps S1401 and S1402 to the sequence diagram in FIG. 12.

As illustrated in FIG. 13, in step S1401, the two-color printing processing unit 1004 of the extension application 1002 determines whether or not the mode is the mode 1 on the basis of information about two-color print function setting acquired in step S1301. In a case where it is determined that the mode is the mode 1 as a result of the determination in step S1401, steps S817 to S820 are executed in order. On the other hand, in a case where it is determined that mode is not the mode 1, that is, the mode is the mode 2 as a result of the determination in step S1401, the processing proceeds to step S1402.

In step S1402, the two-color printing processing unit 1004 (CPU 111) executes the two-color printing processing similarly to step S1304. This two-color printing processing is the two-color printing processing in the mode 2. After step S1402 is executed, steps S817 to S820 are executed in order. It should be noted that necessary image processing is performed on the print data in step S819. In a case where the two-color printing processing has already been performed in step S1402, image processing except for the two-color printing processing is performed in step S819.

### Fourth Embodiment

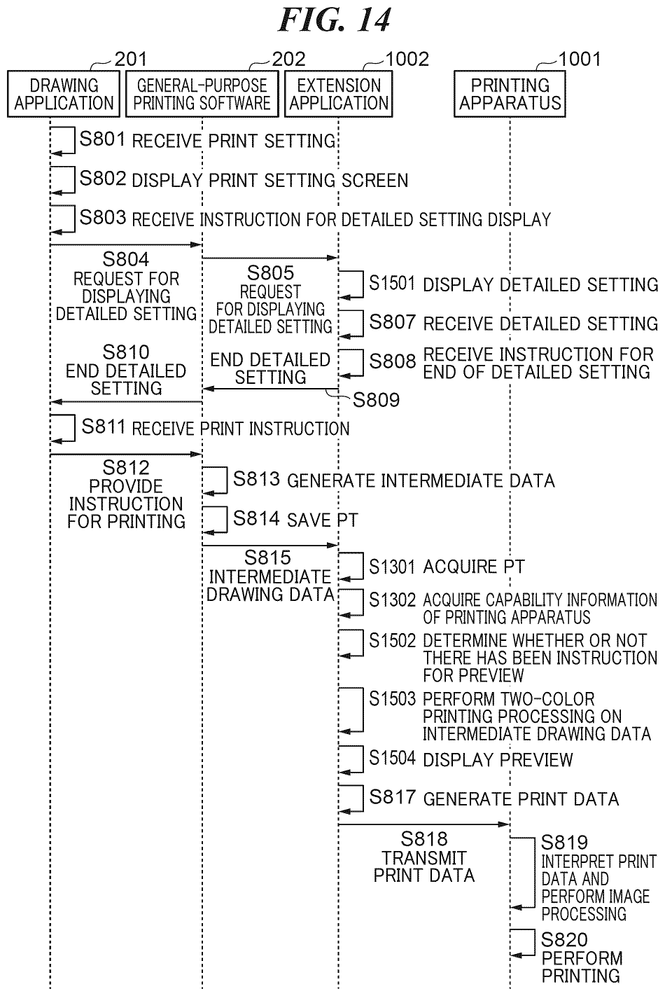

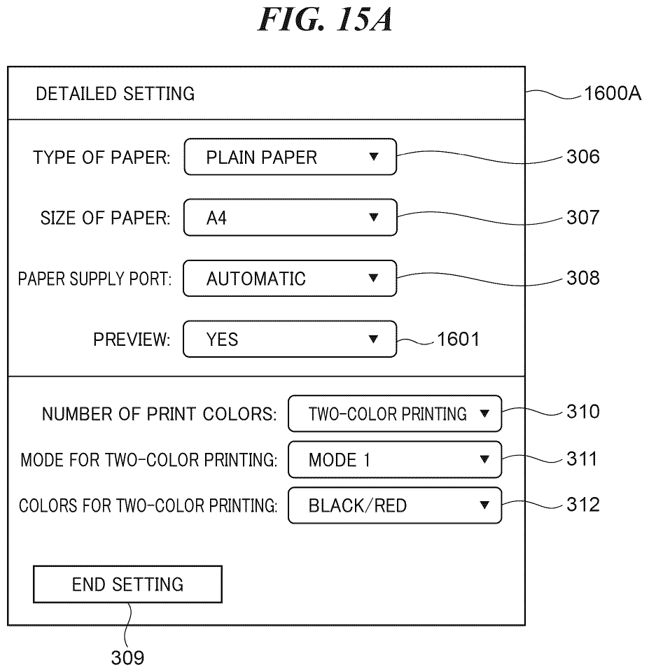

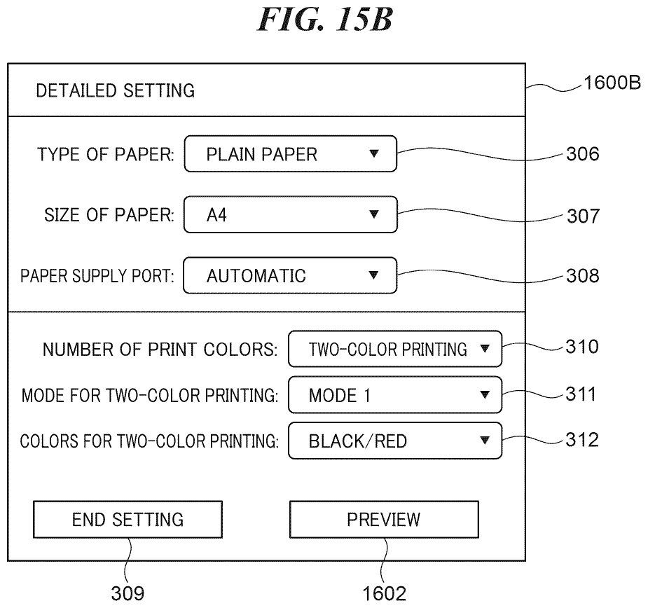

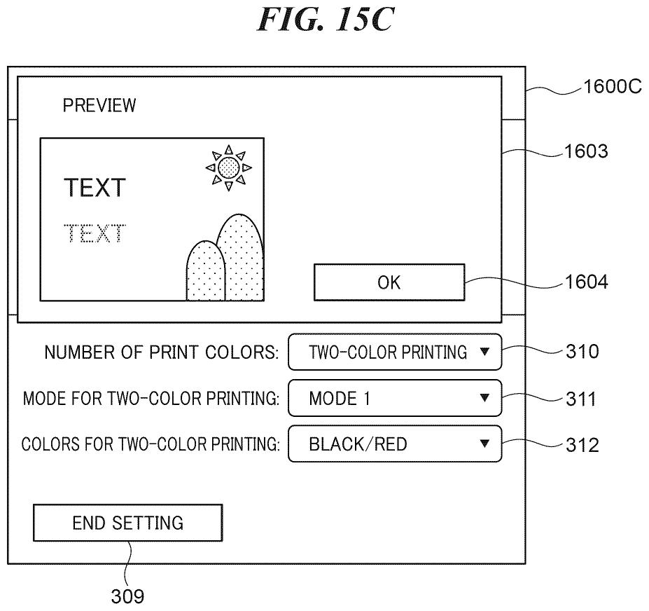

Although a fourth embodiment will be described below with reference to FIGS. 14 and 15A to 15C, differences from the aforementioned embodiments will be mainly described, and description of similar matters will be omitted. Since the color tone of a printed matter significantly change with the two-color printing processing, it is convenient to preview a result of the two-color printing processing before the printed matter is actually obtained. Thus, in the present embodiment, a preview image of the printed matter obtained by a printing apparatus 1001 when the two-color printing processing is performed is displayed.

FIG. 14 is a sequence diagram illustrating processing executed among a drawing application 201, general-purpose printing software 202, an extension application 1002, and a printing apparatus 1001 after the drawing application 201 receives print settings in a printing system 1000 according to the fourth embodiment. The drawing application 201, the general-purpose printing software 202, and the extension application 1002 are stored in a storage device 114, and the operations (steps) of the application and the software illustrated in the sequence diagram in FIG. 14 are implemented by a CPU 111 loading and executing these in a RAM 113 from the storage device 114. In addition, some operations such as data transmission and information input and output are implemented by the CPU 111 working with various interfaces in the host computer 101. In order to clarify a program that mainly works to implement the processing illustrated in the sequence diagram, software units, applications, and the like will be described as grammatical subjects. The sequence diagram in FIG. 14 is a sequence diagram obtained by mainly adding steps S1501 to S1504 to the sequence diagram in FIG. 12.

FIGS. 15A to 15C are diagrams illustrating examples of screens displayed on a display device of the printing system 1000. A detailed setting screen (setting reception screen) 1600A in FIG. 15A is displayed on the display device by the print setting screen extension unit 205 of the extension application 1002. The detailed setting screen 1600A includes a control 306 to a control 312 similarly to the detailed setting screen 300C (see FIG. 3B).

Furthermore, the detailed setting screen 1600A includes a control 1601. The control 1601 is a display selection part that selects whether or not to display a preview image, that is, whether to indicate or hide the preview image. When the control 1601 is operated, a list including options of “yes (display the preview image)” and “no (not display the preview image)” is displayed on the display device, and a user is allowed to select one option from these options. It should be noted that “yes” has been selected with the control 1601 as an example in FIG. 15A. Execution of step S1504 in the flowchart in FIG. 14 is started when the control 1601 is operated.

In a case where “no” has been selected with the control 1601, the two-color printing processing unit 1004, the printing apparatus 1001, or both the two-color printing processing unit 1004 and the printing apparatus 1001 execute the two-color printing processing in accordance with the capability information.

A detailed setting screen 1600B illustrated in FIG. 15B is a variation of the detailed setting screen 1600A. The detailed setting screen 1600B includes a control 1602 instead of the control 1601 on the detailed setting screen 1600A. The processing in steps S807 to S1504 in the flowchart illustrated in FIG. 14 is executed when the control 1602 is operated.

A detailed setting screen 1600C illustrated in FIG. 15C is a screen obtained by partially changing the detailed setting screen 1600A after the control 1601 on the detailed setting screen 1600A is operated. A region 1603 is displayed instead of the controls 306 to 308 on the detailed setting screen 1600C. The region 1603 indicates a preview image of a printed matter to be obtained by the printing apparatus 1001 when the two-color printing processing is performed. It should be noted that the preview image may be displayed as a part of the detailed setting screen 1600A. In addition, the region 1603 includes a control 1604. The screen returns to the detailed setting screen 1600A when the control 1604 is operated.

As illustrated in FIG. 14, the processing proceeds to step S1501 after execution of step S805. In step S1501, the print setting screen extension unit 205 of the extension application 1002 displays the detailed setting screen 1600A (see FIG. 15A) on the display device of the printing system 1000. After execution of step S1501, steps S807 to S815, step S1301, and step S1302 are executed in order.

After execution of step S1302, the processing proceeds to step S1502. In step S1502, the print setting screen extension unit 205 determines whether or not a control 1601 on a detailed setting screen 1600A displayed in step S1501 has been operated, that is, whether or not there has been an instruction to display a preview image. In a case where it is determined that the control 1601 has been operated as a result of the determination in step S1502, the processing proceeds to step S1503.

In step S1503, the two-color printing processing unit 1004 executes the two-color printing processing similarly to step S1304.

In step S1504, the print setting screen extension unit 205 of the extension application 1002 displays the detailed setting screen 1600C (see FIG. 15B) on the display device of the printing system 1000. As described above, the detailed setting screen 1600C includes a preview image. This allows users to recognize a state of a printed matter that reflects the two-color printing processing before printing of the printed matter. The screen returns to the detailed setting screen 1600A when the control 1604 on the detailed setting screen 1600C is operated. Then, the processing proceeds to steps S817 to S820 in order when the control 309 is operated in a state where “no (not display the preview image)” is selected with the control 1601 on the detailed setting screen 1600A.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-031327, filed Mar. 1, 2024, which is hereby incorporated by reference wherein in its entirety.

What is claimed is:

1. A non-transitory computer-readable storage medium storing a program which is executed by a computer and is configured for supporting a general-purpose program that generates data being printable by printing apparatuses from a plurality of manufacturers, the program causing the computer to execute:
causing a display to display a setting reception screen that receives a setting for color reduction processing of reducing kinds of colors included in print data, which is targeted for printing by a printing apparatus, to two or more kinds of colors and of causing the printing apparatus to print the print data; and
transmitting a setting for the color reduction processing received through the setting reception screen to the printing apparatus.

2. The non-transitory computer-readable storage medium according to claim 1, wherein the setting for the color reduction processing transmitted to the printing apparatuses is used by the printing apparatus to convert data generated by the general-purpose program into the print data to be subjected to printing based on the color reduction processing and to perform the printing on the converted print data.

3. The non-transitory computer-readable storage medium according to claim 1, wherein the program further causes the computer to execute:
acquiring, from the printing apparatus, capability information about capabilities of the printing apparatus to perform printing, prior to causing the display to display the setting reception screen;
determining whether or not the acquired capability information includes information that causes display of the setting reception screen;
in a case where it is determined that the acquired capability information includes the information that causes the display of the setting reception screen, causing the display to display the setting reception screen; and
in a case where it is determined that the acquired capability information does not include the information that causes the display of the setting reception screen, skipping causing the display to display the setting reception screen.

4. The non-transitory computer-readable storage medium according to claim 1, wherein the setting reception screen includes an execution selecting part that selects, as a setting for the color reduction processing, whether or not to execute the color reduction processing.

5. The non-transitory computer-readable storage medium according to claim 1, wherein the setting reception screen includes a switching part that switches a mode, as a setting for the color reduction processing, between a first mode and a second mode, the first mode being a mode in which chromatic colors are converted into one predetermined chromatic color regardless of kinds of the chromatic colors while achromatic colors are left as the achromatic colors regardless of kinds of the achromatic colors, the second mode being a mode in which one predetermined color and colors similar to the one predetermined color are converted into the one predetermined color while colors other than the one predetermined color and the colors similar to the one predetermined color are converted into another predetermined color.

6. The non-transitory computer-readable storage medium according to claim 1, wherein the setting reception screen includes a color designating part that designates colors to be used in the color reduction processing as a setting for the color reduction processing.

7. The non-transitory computer-readable storage medium according to claim 6, wherein a plurality of combinations of two colors is set in advance for the color designating part, and the color designating part allows to select one combination from the plurality of combinations.

8. The non-transitory computer-readable storage medium according to claim 1, wherein the setting reception screen includes a preview image of a printed matter to be obtained through printing of the print data by the printing apparatus.

9. The non-transitory computer-readable storage medium according to claim 8, wherein the setting reception screen includes a display selection part that selects whether or not to display the preview image.

10. The non-transitory computer-readable storage medium according to claim 1, wherein the color reduction processing is not executable on the printing apparatus by the general-purpose program.

11. The non-transitory computer-readable storage medium according to claim 1, wherein a program that runs in accordance with an Internet Printing Protocol (IPP) is used as the general-purpose program.

12. A non-transitory computer-readable storage medium storing a program which is executed by a computer and is configured for supporting a general-purpose program that generates data being printable by printing apparatuses from a plurality of manufacturers, the program causing the computer to execute:
causing a display to display a setting reception screen that receives a setting for color reduction processing of reducing kinds of colors included in print data, which is targeted for printing by a printing apparatus, to two or more kinds of colors and of causing the printing apparatus to print the print data;
performing conversion processing of converting data generated by the general-purpose program into the print data to be subjected to printing based on the color reduction processing with a setting for the color reduction processing received through the setting reception screen; and
transmitting the print data converted through the conversion processing to the printing apparatus.

13. The non-transitory computer-readable storage medium according to claim 12, wherein the program further causes the computer to execute:
acquiring, from the printing apparatus, capability information about capabilities of the printing apparatus to perform printing, prior to causing the display to display the setting reception screen;
determining whether or not the acquired capability information includes information indicating that the conversion processing is executable on the printing apparatus; and
omitting the conversion processing performed by the computer executing the program and causing the printing apparatus to perform the conversion processing, in a case where it is determined that the acquired capability information includes information indicating that the conversion processing is executable on the printing apparatus.

14. The non-transitory computer-readable storage medium according to claim 12, wherein the print data transmitted to the printing apparatus is printed by the printing apparatus.

15. The non-transitory computer-readable storage medium according to claim 12, wherein the program further causes the computer to execute:
acquiring, from the printing apparatus, capability information about capabilities of the printing apparatus to perform printing, prior to causing the display to display the setting reception screen;
determining whether or not the acquired capability information includes information that causes display of the setting reception screen;
in a case where it is determined that the acquired capability information includes the information that causes the display of the setting reception screen, causing the display to display the setting reception screen; and
in a case where it is determined that the acquired capability information does not include the information that causes the display of the setting reception screen, skipping causing the display to display the setting reception screen.

16. The non-transitory computer-readable storage medium according to claim 12, wherein the setting reception screen includes an execution selecting part that selects, as a setting for the color reduction processing, whether or not to execute the color reduction processing.

17. The non-transitory computer-readable storage medium according to claim 12, wherein the setting reception screen includes a switching part that switches a mode, as a setting for the color reduction processing, between a first mode and a second mode, the first mode being a mode in which chromatic colors are converted into one predetermined chromatic color regardless of kinds of the chromatic colors while achromatic colors are left as the achromatic colors regardless of kinds of the achromatic colors, the second mode being a mode in which one predetermined color and colors similar to the one predetermined color are converted into the one predetermined color while colors other than the one predetermined color and the colors similar to the one predetermined color are converted into another predetermined color.

18. The non-transitory computer-readable storage medium according to claim 12, wherein the setting reception screen includes a color designating part that designates colors to be used in the color reduction processing as a setting for the color reduction processing.

19. The non-transitory computer-readable storage medium according to claim 12, wherein a program that runs in accordance with an Internet Printing Protocol (IPP) is used as the general-purpose program.

20. A control method of performing control to support a general-purpose program that generates data being printable by printing apparatuses from a plurality of manufacturers, the method comprising:
causing a display to display a setting reception screen that receives a setting for color reduction processing of reducing kinds of colors included in print data, which is targeted for printing by a printing apparatus, to two or more kinds of colors and of causing the printing apparatus to print the print data; and
transmitting a setting for the color reduction processing received through the setting reception screen to the printing apparatus.
